(19) United States
(12) Patent Application Publication
(10) Pub. No.: US 2002/0141643 A1
(43) Pub. Date: Oct. 3, 2002

(54) Method for creating and operating control systems

(76) Inventor: Denny Jaeger, Oakland, CA (US)

Correspondence Address: Harris Zimmerman, Law Offices of Harris Zimmerman, Suite 710, 1330 Broadway, Oakland, CA, 94612-2506, US

(21) Appl. No.: 09/785,049

(22) Filed: Feb. 15, 2001

(51) Int. Cl. G06K 9/00

(52) U.S. Cl. 382/181

(57) ABSTRACT

A method for on-screen programming of an electronic device includes hand drawing of graphic inputs on-screen. The graphic inputs are recognized by determining the vertices, trend, size, context, and other parameters, and, once recognized, are converted to functional objects on-screen. The functional objects may be linked in a selected order by arrows or lines to produce a desired output, or may be ganged for action in common. The device may provide a control panel for signal processing, or a telephone display for controlling call blocking and call answering.

### BACKGROUND OF THE INVENTION

The present invention relates to user programmable control systems and, more particularly, to such devices that accept hand drawn inputs from a touch screen, mouse, trackball, and the like.

There are known in the prior art many computer systems that employ a touch screen or stylus to permit the user to enter graphics that may be interpreted as command, control, or communication inputs. These systems generally are programmed with some form of recognition software that distinguishes the written inputs of the user, converts the recognized inputs to machine-intelligible format, and carries out the graphic directives of the user. It is apparent that the crux of such a system is the recognition software, especially its reliability, ability to distinguish a wide range of graphic inputs, and speed of operation. These factors have been poorly realized in prior art systems.

Furthermore, the architecture of such systems is often complex and multi-layered. As a result, it is typically necessary for a user to define a complete operation by first selecting individual function blocks from a menu, associating data files with each appropriate function, and specifying the connections among the function blocks and data files. It is then necessary to construct a control panel by selecting control elements from a menu, selecting display elements from a menu, and tying each control and display element to the respective underlying function block. This process may be arduous, and, moreover, does not adapt well to changes that the user may desire or require. That is, any change in the function block relationships or data file sources may cause the control panel and display elements to fail to operate properly. Likewise, any change in the display or control arrangement may adversely affect the underlying functional block arrangement. Because of these types of problems, graphic programming of computers has not advanced to a point where an average user may take full advantage of the simplicity of the graphic input process.

### SUMMARY OF THE INVENTION

This invention generally comprises an architecture for the creation and utilization of hand drawn objects, for the implementation and utilization of digital equipment, word processing and user-definable, associative, object based control of existing software and hardware systems. In another aspect of the invention, the invention provides a graphic programming and control system that is based on objects that are drawn on-screen by the user to represent machines, components, communications devices and connections that describe a fully functional process. In another aspect of the invention, the invention provides controls for controlling any type of electronic equipment or system, either analog or digital. In another aspect of the invention, the invention provides for methods that allow software to “understand” what users are trying to do by what they are drawing on a screen.

This invention includes the following areas of development:

1. The ability to recognize hand drawn objects in real time that are drawn anywhere on a screen, regardless of how big the screen is. The apparatus for inputting data on the screen can be either a mouse (or its equivalent) or a touch screen (or its equivalent). Such recognition is optimized for such performance and is capable of achieving pixel accurate recognition of hand drawing and the location of such drawing on a display and/or touch screen.

2. Unique object recognition tests and combinations of tests are utilized which maximize the real time recognition of hand drawn objects. These tests include: Wide Pen test, the “slice” test (which can take into account every point of a hand drawn object in the recognition process of that object), Golden Clues, “pixel length” with “magic numbers”, use of “trend” in combination with other tests for fast recognition results,

3. The ability to recognize and map the speed and direction that an object was drawn and to utilize this information in the recognition of that object.

4. The ability of different object recognition algorithms to “weigh” certain types of information and thus apply a higher importance to certain types of information than other types of information in the object recognition process.

5. Special types of recognition algorithms can become adaptive; i.e., they are capable of modifying their own parameters in real time, in order to more effectively recognize different aspects of hand drawn objects. Adaptive behavior exists in at least the following recognition processes: “pixel length” calculations for angle of deviation, the size of the Wide Pen Stroke, the weight of individual Golden Clues, and the proximity of a hand drawn object to an existing object.

6. “Magic Numbers” are used for object recognition where the values of such numbers can be separately optimized for each individual object or individual instances of the drawing of entire objects or parts of objects which this software seeks to recognize. These are numbers that are derived empirically, using intensive study of how to best recognize hand drawn objects, like stars, rectangles, check marks, etc. These numbers affect the recognition of things like: length, angle, number of deviations, trend, straightness, weight of things—use of detected golden clues, amount of influence of golden clues on existing tests, etc.

7. A special “agglomeration technique” permits a user to add to an existing hand drawn object (by drawing one or more additional objects) to change the original object's identity, purpose, function, mode, etc. Although the recognition of objects composed of plural strokes is not new, agglomeration as used herein is an innovation. Agglomeration is the ability to draw an object and THEN LATER at any time in the future, draw another stroke (or strokes) that can be recognized as an “additional stroke(s)” added to the original stroke. The added strokes are analyzed together with the original strokes to redefine the identity of the original object. The agglomeration process is subject to a proximity default gap consideration. That is, the distance from the “additional stroke” (or strokes) to the original object (stroke) determines whether this software considers the second stroke(s) as an additional stroke to be added to the original stroke for the purpose of modifying its recognition as an object. If the second and subsequent strokes intersect the original stroke, then the additional strokes will definitely be considered as additions to the original stroke. One practical default gap for this purpose could be 12 pixels (approximately ⅛ inch on a standard VGA monitor).

8. A.) The ability to draw a control panel, or its equivalent, in one programming step and have that control panel become one or more operations or a piece of equipment or a fully operational system, without requiring additional complex programming. In other words, one single level of programming architecture can accomplish what the prior art requires to do in many complex levels.

B.) Recognized hand drawn objects can be interpreted as symbolic elements that describe functions to be carried out by the software.

C.) Associative programming modes permit objects to be drawn in such a way that the new hand drawn objects' characteristics (such as signal flow, functions, actions, modes and the like) are automatically defined by these objects' proximity to other previously existing objects.

D.) Formulae for a functional device or process as can be represented in an Info Window or its equivalent.

9. All algorithms that control the recognition of hand drawn objects can have user-defined parameters. This eliminates dependence upon predefined object recognition parameters. With the use of user-defined parameters, these recognition algorithms can be adapted to a user's own style of drawing.

10. Hand drawn objects and the recognition of such can be utilized with actual physical self-adhering devices, as found in pending patent application Ser. No. 09/670,610, filed Sep. 26, 2000. Hand drawn graphics including hand drawn text (hand drawn entries) can be used to both select and define virtual and physical devices interchangeably. With regards to physical devices, hand drawn entries can be used to define the function of such devices before or after they are placed on the surface of a screen and operated according to the hand drawn entries' properties. These properties could include shape, size, color, orientation, function, proximity, etc.

11. Unique contexts can be applied to the recognition of hand drawn objects. Some of these contexts include: location, proximity, orientation, size, color, time, function, action and mode, and more.

12. The ability to store and utilize the “first pen down” information and the direction of the pen stroke for any hand drawn object for the purpose of aiding the recognition of that object.

13. User definable “gap default”. Gap default can be per object.

14. The use of “arrow logics” and “line logics” for programming connections, functions, links and behaviors and many types of associations between hand drawn objects and/or any graphical objects and/or physical objects.

15. The ability to recognize a “free drawn” object(s) in real time and the ability to determine the action that the drawing of this object(s) precipitates.

16. The ability to change dynamically the results of drawing an object. For instance, the ability to change the machine that a rectangle represents, according to a user-defined function(s). The ability to change dynamically the results that this “rectangle machine” produces when a rectangle is drawn on a screen. The ability to draw such rectangle in different colors, which in turn can make different things happen. The ability to draw such rectangle in a certain location(s) on a screen, where the location of such drawing can affect other objects and/or their associated machines in certain ways determined by location. By drawing connecting lines, graphics can be programmed to do different things according to what those graphics are or what they represent.

17. The ability to assign a color to an object, where this color defines this object's function and/or assignment and/or properties and/or actions, etc.

The various principles of operation of the invention offer the following advantages over prior art.

Increased Flexibility

Users of this system can explore the full potential of a completely dynamically allocated processor hardware and software architecture.

Total User Customization

Users of this system can customize every operation of the equipment they operate by drawing the controls for this equipment (and/or drawing operational functions and/or conditions for physical controls) to suit their own style and method of working. Furthermore, the relationship of these controls to each other and to controls for other “drawn” or existing pieces of equipment is customizable as well. In addition, the structural designation of this equipment (what type of equipment it is) is fully automatable. This means that the type of this drawn equipment can change from one point in time to another according to hand drawn designations relative to various time scales.

Speed

The implementation and utilization of hand drawn equipment is faster to operate and designate that other types of equipment.

More Familiar and Intuitive Operation

Since the user may draw freehand the operation of every piece of equipment being used, the operation can always be intimately familiar and completely intuitive for that user.

Adaptability of Hand Drawn Controls to Physical Controls

Physical controls, i.e., knobs, faders, joysticks, can be added to hand drawn controls in this architectural approach. Equipment can be hand drawn, showing knobs, faders and joysticks as graphic elements of the equipment. Then, as desired, physical knobs, faders and joysticks can be used to enhance or replace these hand drawn graphics, which then become the automatic operation(s) for the physical devices replacing them. The following US patents and patent application detail such controls: U.S. Pat. Nos. 5,572,239; 5,977,955; 5,805,146; 5,805,145; 5,936,613; 5,774,115; and Ser. No. 09/670,610, filed Sep. 26, 2000. These descriptions are incorporated herein by reference. The latter reference describes “crack and peel” devices that are fabricated as a plurality of inexpensive devices on a single sheet, each device being separable from the sheet and individually adhered to the touch screen or display screen, as appropriate. Crack and peel devices may include, inter alia, knobs, faders, joysticks, and the like.

Open Architecture

Hand drawn graphics can be used to create any known type of machine, signal path, signal flow, order of events, types of devices, groupings of devices, relationships between devices, etc. A single hand drawn object can be utilized to implement a complex machine at any time, where the details of the implementation of that machine remain fully user-definable. Supports dynamic allocation of resources—The time that an object exists, the function and action of that object and that object's relationship to other objects or other portions of objects (even to other objects contained within an object itself) are constantly changeable over time.

Improvements Over Prior Art Architectures.

This Architecture Does Not Rely Upon Predefined Lists of Icons

Predefined icons or images stored in tables or menus, as is common in the art, are not needed in this architecture. Hand drawn images are recognized in real time as they are drawn (with a user input device) on a touch screen or with a mouse on a conventional monitor or display. Hand drawn images are not compared to a list of predefined graphics. The ability to “know” or recognize what are various hand drawn images resides in the software code as sets of rules and as real time algorithms. The system does not use comparisons to library examples of preexisting objects. It does not use an external comparison reference to determine what are the hand drawn graphics. The algorithms are adaptive. They can take into account and analyze what is drawn, and they can modify the recognition algorithm, if need be, in real time.

Advantages of this Approach Include the Following:

A) Ability to Recognize Individual Drawing Styles.

Object recognition rules enable a user to draw objects in their own personal style; how an object is drawn is an important factor in recognizing it, as opposed to merely how it looks. Users of this software generally do not need to learn to draw objects that conform to rigid formulae. On the contrary, the point of utilizing recognition rules that are optimized for each individual hand drawn object is to permit the maximum number of users to draw these objects in ways that are familiar, and have these objects recognized with a high degree of accuracy.

B) Size is Recognized.

The size of an image is recognizable according to how big or small it is drawn.

C) Direction is Recognized.

The direction of an image, i.e., an arrow or a bracket is recognizable according to how it is drawn.

C) Rotation is Recognized.

The rotation of an image is recognizable according to how it is drawn. For example, a set of conditions could be created for a bracket where if a bracket were drawn in a horizontal or vertical orientation, it would be recognized, but if it were drawn rotated by 90 degrees, it would not be recognized.

D) The Color of an Image is Recognized.

The color of an image is recognizable according to the color of “ink” that is selected when the image is drawn, or to a change in the color of the stroke that defines an object. Color can be used to denote association or non-association of hand drawn entries.

E) The Location of an Image is Recognized.

The exact location of an image is recognizable to the precise pixel(s) according to where the image is drawn. For instance, the exact point of an arrow is located by the single pixel at the arrow point of the hand drawn arrow. The starting and ending points of any hand drawn entry are precisely located by two pixels, one for the beginning and one for the end of the hand drawn entry. Every point along this stroke can be utilized for analysis if necessary. As another example, when drawing a fader controller, the position that the fader cap is drawn along the fader travel guide determines the exact location of that fader cap, rather than always having a predetermined fader appear with the fader cap in a default location.

F) A Hand Drawn Control Panel Becomes the Flow Diagram for the Equipment that This Control Panel Operates.

The need to designate signal flow as a separate block diagram, as is common in the art, may be eliminated with this architectural approach. Using this approach, users need only hand draw the controls for a desired piece of equipment. Their placement of the controls can comprise the flow diagram directly. In this case, no additional block diagrams, charts, lists or menus are needed to designate signal flow. So, in one plane of graphic user interface, both the controls and the entire operation of a piece of equipment can be drawn as one cohesive architecture, known in the art as a control panel.

G) A Single Free Drawn Graphic Can Represent a Complex Piece of Equipment.

A single graphic, i.e., a blue rectangle, a green star, a red ellipse, etc. can be drawn and then have it recognized as an action or have it represent a piece of equipment, including its control panel. Such action or equipment can be implemented by the drawing of such graphic on a screen.

In one aspect of the invention, the control panel is the equipment. It is its operation, including its signal flow. It is its functionality, including the operability of each hand drawn object and their relationship to each other to create a more complex piece of equipment. By hand drawing a control panel the user of this architecture may create everything that is associated with that panel. By drawing the panel, the user creates the equipment or instrument. This one step process can produce a ready-to-use piece of equipment. This control panel can also be added to an existing piece of equipment in such a manner that the existing equipment's signal flow will apply to the hand drawn panel's equipment. Furthermore, this control panel and its associated equipment can be represented by a single hand drawn object, like a rectangle. Such equipment can be immediately recalled and implemented by simply drawing such object.

H) Utilization and Expansion of Existing Architectures.

With this architecture, hand drawn equipment can immediately utilize existing inputs and outputs without having to be specified. A new piece of equipment can be drawn “in place”, directly in a signal path or directly associated with an existing piece of equipment (also represented by graphics, either hand drawn or recalled from some source). By drawing a new piece of equipment as just described, the type of equipment, signal flow, general architecture, operational protocols and I/O can all be immediately “taken” from one or more existing pieces of equipment—equipment already represented on a display as graphic and/or physical tactile elements.

I) Arrow Logics.

The logic of connections between individual elements and between pieces of equipment is user defined. Arrows can be hand drawn to designate links between any graphic object or group of objects and any other graphic object or group of objects. These links are user-definable and can represent actions, functions, definitions and the like. A single hand drawn arrow graphic can be used to cause virtually any function, action, definition, assignment, etc. that is possible on a given system. Function and/or action and/or assignments and/or definitions (functions) are not predetermined as in most prior art systems. Functions of arrows or lines are not required to be selected in predetermined lists, menus, icons and the like. They can be determined by drawing objects and/or descriptive text which can be entered into an info window or its equivalent. Furthermore, functions of hand drawn arrows can be fully determined by the use of these arrows. The graphical context which the arrow encompasses may determine its function. This includes criteria like: where does the arrow originate?; where does it end?; what types of devices is it drawn between?; what color is the arrow?; when was the arrow drawn or when was it started and when was it completed?

In summary, the definition(s) of arrows' functions can be determined by the graphical context of the arrows: the way the arrows are drawn, where the arrows are drawn, the span of the graphical context of the arrows, where the arrows start and where they end up, and as mentioned above, when they were drawn or when they were started and then completed. It is the graphical context which the arrow encompasses together with the user defined nature of an arrow (herein termed “arrow logics”) that can define that arrow's function. When one draws an arrow between certain types of graphical objects, different operations may be commanded, depending upon the context(s) of the arrow.

For instance, one could draw an arrow from a piece of text, i.e. “volume”, to a knob. The conjoining of the text and knob by the arrow may be defined to mean that the text is assigned to that knob. In other words, that text is incorporated in the function of that knob, i.e., it makes the knob a volume control. But if one drew an arrow between two knobs it could determine that the two knobs are linked together. NOTE: every object recognized by this system may have its own info window that can be used for the user-specification of aesthetic properties, definitions, assignment(s), operations, functions, actions and the like for that object.

Given two knobs depicted on a screen side by side, one can link these two knobs by drawing an arrow between them. Note that the direction of the arrow between the knobs is crucial in defining the nature of the link. For instance, if the arrowhead is pointing from the first knob to the second knob, this relationship may be defined to mean that the first knob is the master control and the second knob is the slave control. So, as one turns the first knob, the second knob will turn a proportionate angle. Thus it is evident that on the same screen or panel the arrow has done different things according to where and how one has drawn it.

Also one can interject other objects along the stem of an arrow and further customize or modify the operation of an arrow. For instance, one could draw an arrow between a volume fader for a console channel and a boost/cut knob for an equalizer. Then in the stem of the arrow you could draw “×0.5” or “times 0.5” or just “½”. This could mean, as one moves the fader X distance which equals X volume, the boost/cut knob is moved half that distance. So for X distance on the volume of the fader, the brightness or equalization change effected by the boost/cut knob changes by half the value of the change of the fader.

Also there are graphics which can be drawn on a screen which will keep hand drawn objects visible, which would normally not remain visible after they have been drawn and their function has been implemented. An arrow is a good example of this. Arrows generally represent actions that are governed by logics and as such, once an arrow is drawn and recognized and its action carried out, keeping the arrow itself visible on the screen may not be desirable. So, usually drawing an arrow causes something to happen and when that “something” happens, the arrow no longer needs to remain visible. Also, the arrow may cause a series of graphics to appear which illustrate the action that the drawing of the arrow just caused. Again, generally in these cases there would be no reason to have the arrow itself remain visible on the screen, but in the case where a user requires such an arrow to remain visible, the drawing of a graphic can accomplish this purpose. Examples of other objects that may not remain visible once their action has been carried out is an “X” that is being used to delete something, a lasso used to select one or more objects, a connecting line used to select or group one or more objects (as shown in FIGS. 26A and 26B), and an ellipse used to select one or more objects (as shown in FIG. 24C). Note: It could also be stated that all of these example objects represent functional devices.

A functional device need not remain visible to be a functional device nor does it have to be visible to be a functional device. Once an arrow has been drawn between two or more devices, objects, and the like, even though the arrow is no longer visible, it can remain active and can be made visible again in the future for purposes of modifying the objects it is affecting or to modify its properties, i.e., its assignment and action. (The properties of a functional device are explained in detail later).

In this invention many parameters exist in various object recognition algorithms that are user-modifiable. The modifications are made by entering in new values for certain types of recognition functions. Such functions can include: thresholds for angles of deviation, choosing different “magic numbers” for various recognition processes, choosing whether to weight Golden Clues and/or to categorize those clues in the utilization of such clues in object recognition and more.

Architecture of the Invention

The invention provides an architecture that permits the hand drawing of objects which can then be turned into virtual or actual equipment, configurable hardware, processes, actions, functions and the like, with software being implemented, processes, actions, functions, etc. being created, controlled and/or initiated, and/or configurable hardware being configured according to how the controls and objects are drawn and linked. Another architectural approach is similar to the first, but has the added ability to recognize typed text, spoken text and hand drawn text and use this information in the conversion of hand drawn objects into equipment, processes, actions, functions and the like.

1. The software carries out the following methods of hand drawn object recognition:

Use of Vertex Detection.

Use of the Wide Pen test.

The use of “Pixel Length”.

The use of “Golden Clues”.

The use of “trend”.

The use of “size”.

The use of “proximity”.

The use of “orientation”.

The use of “function”.

The use of “action”.

The use of “context”.

2. After recognition, hand drawn objects are dynamically created with the help of unique geometric analyses.

3. Use of adaptive recognition algorithms, i.e., “pixel length”, “Wide Pen”, “Golden Clue”, and adaptive modification of other recognition algorithms, such as “proximity”, “orientation”, etc.

4. The ability to “know” when and where any hand drawn object was drawn and as an optional additional consideration, how fast each segment of the drawing was drawn in real time, and the ability to “use” this information in the processes of object recognition. Note: The idea of taking into account what a person drew first to create an object, and then modifying the recognition routine to weight its decisions based upon the progression of the drawn stroke(s) for that object, is a powerful part of this software approach.

For example, if 80% of the time used to hand draw an object is used to draw the first vertex, e.g., the software detected a vertex that existed in time 80% past the pen down time, then it would be very unlikely that this object would be a rectangle. The theory is that spending 80% of the total drawing time on a single horizontal and single vertical stroke (one of these strokes would precede and one would follow a recognized angle of deviation) is an unlikely event for anyone drawing an object that has four 90 degree angles.

The significant point here is that this software may take into account how much time is spent drawing which part of an object. Then this “time factor” may be utilized according to various rules as part of the algorithm to interpret the likelihood that a detected angle of deviation could be part of a certain type of object. As a general course of understanding, for simple objects, i.e., rectangles, squares, equilateral triangles, etc., we have found that the first drawn vertex is usually the most accurate and that the last is the least accurate.

Being able to “know” when a vertex was drawn and how much time was spent drawing it enables this software to weight the importance of that portion of the drawing. The “time spent” drawing a certain part of a hand drawn object generally equates to the “care” that was taken to draw that part of the object. By “knowing” where the most care was taken in the drawing of an object, this software increases its chances of knowing what the object is. This is because it is unlikely that someone drawing an object would take special care to draw a part of the object more accurately, if this part of the object were not an important feature or signature of its uniqueness as an object.

Not all objects are drawn in a manner where the only the first vertex is given special care by the drawer. Sometimes more than one part of an object may be given special attention because it is the combination of two or more geometric shapes that clearly distinguishes one drawn object from another. An example of this would be a hand drawn folder. This folder consists of a rectangle, plus a tab. For such an object, the first vertex of the rectangle and the vertices of the tab may both be drawn with care and thus be more accurate, while the other vertices of the rectangle may be drawn less accurately. One of the advancements of this software is the ability to detect and utilize this information and offer a high degree of reliability for the recognition of objects that would appear to be the same to other object recognition software.

Generally the speed of what was drawn can be determined reasonably accurately by looking at the distance between points in the hand drawn stroke. The farther apart the points, the faster the hand drawn entry was drawn and vice versa. In addition to this approach, the drawing itself or each point of the drawing can have a time stamp stored with it that can store the timings of the drawing of each point in each segment of the object. So, the ability to store the actual timing of the drawing can be used as an optional way to measure the speed of the drawing.

The method of looking for the different distances between points only works on systems which use a constant scan rate (to receive input from a touch screen or computer pointer device). Systems that use an irregular scan rate may require the timer approach. The significant point is there is a method for determining the speed of drawing with this software on any hardware/software system, i.e., PC, Mac, embedded systems, stand alone processors, etc.

Speed as an Adaptive Determinant

As noted above, this software can make use of the distance between points to determine the speed of the hand draw. Assuming that the drawing input device (mouse, pen, finger, etc.) is scanned at a set rate, the slower someone draws, the more points there will be per segment. This information may be used to interpret the speed of the drawing (thus providing information on the care spent on drawing certain portions of the object). If the points are very close together, someone was probably trying extra hard to draw carefully.

This “speed of drawing” criteria could be used to make any number of recognition tests adaptive. For example, this data could be used to make certain recognition tests stricter. For instance, the Wide Pen stroke (discussed below in detail later) could be made narrower or certain thresholds could be made to require a smaller percentage of error for successful recognition, etc.

### BRIEF DESCRIPTION OF THE DRAWINGS

FIG. 1 is a flow chart depicting the general procedures employed to identify an object drawn on a computer input screen.

FIG. 2 is a depiction of a hand drawn triangle, showing the points that determine the shape and the definition of a segment.

FIG. 3 is an enlarged depiction of one leg of the triangle of FIG. 2, and the points that form that leg.

FIG. 4 is an enlarged view of the leg of FIG. 3, showing the graphic definition of a slice used in the stroke analysis algorithm of the invention.

FIG. 5 is a flow chart depicting the routine that identifies each slice within a hand drawn entry.

FIGS. 6A-6C are flow charts depicting the routines that determines deviation, vertices, and segments of a hand drawn entry.

FIGS. 7-9 are a sequence of views depicting graphically the initiation and progression of the slice analysis of a hand drawn entry.

FIGS. 10 and 11 are a sequence of views depicting graphically the determination of the vertex of a hand drawn entry.

FIG. 12 is a block diagram of the analytic tests used by the algorithm of the present invention.

FIGS. 13A-13C are a sequence of views depicting one implementation of the wide pen test.

FIGS. 14A-14C are three examples of the golden clue test for object recognition.

FIG. 15 is graphic depiction of a hand drawn folder object, showing points in the hand drawn entry and significant vertices.

FIG. 16 is a graphic depiction of a hand drawn circle.

FIG. 17 is a graphic depiction of a hand drawn semicircle.

FIG. 18 is a graphic depiction of a hand drawn arrow, enclosed in a minimal box.

FIG. 19 is a graphic representation of a hand drawn check mark, enclosed in a minimal box.

FIG. 20 is a juxtaposition of the enclosing boxes of FIGS. 18 and 19, showing a comparison of the typical sizes of an arrow and a check mark.

FIGS. 21A and 21B are graphic representations of hand drawn bracket shapes, drawn in horizontal and oblique dispositions.

FIGS. 22A and 22B are graphic representations of arrows, drawn in horizontal and oblique dispositions.

FIG. 23 is a chart depicting a partial list of hand drawn objects, their machine drawn counterparts, and the function assigned to them.

FIGS. 24A-24E depict various techniques provided by the invention to set or modify the attributes of a graphic object.

FIGS. 25A-25C are graphic depictions of the use of function symbol equivalencies to convey functionality between objects.

FIGS. 26A and 26B are graphic depictions of typical uses of line logic to select and functionally connect on-screen objects of similar types.

FIG. 27 is a graphic depiction of a typical use of line logic to select and connect on-screen objects with a function displayed on-screen.

FIG. 28 is a graphic depiction of the functions assigned to the selected knobs by the line logic of FIG. 27.

FIG. 29 is a graphic depiction of a typical use of line logic to select and link the functions of on-screen objects.

FIG. 30 is another graphic depiction of a typical use of line logic to select and link the functions of on-screen objects.

FIG. 31 is a graphic representation of arrow logic used to redirect the default signal flow path through a signal processing arrangement.

FIG. 32 is a graphic representation of the signal processing arrangement of FIG. 31, showing the redirected signal flow path therethrough.

FIG. 33 is a graphic representation of arrow logic used to redirect the default signal flow path through a signal processing arrangement.

FIG. 34 is a graphic representation of a hand drawn chop bracket used to edit a waveform that is displayed graphically.

FIG. 35 is a graphic representation of a hand drawn symbol used to create a cross-fade between two waveforms displayed graphically.

FIGS. 36-38 are a sequence of graphic representations showing a hand drawn control panel, the machine generated display upon recognition of the hand drawn control panel, and a folder that is assigned the functionality of the control panel.

FIG. 39 is a sequence showing an on-screen telephone device and the establishment of selective call blocking by entry of hand drawn objects.

FIG. 40 is a sequence showing an on-screen telephone device and the display of further telephone controls by entry of a hand drawn object.

FIG. 41 is a sequence showing an on-screen telephone device and the display of telephone answering machine controls by entry of a hand drawn object.

FIG. 42 is a sequence showing the on-screen telephone device as in FIG. 41, depicting the designation of separate answering messages to different callers by entry of hand drawn objects.

FIG. 43 is a sequence showing an on-screen telephone device having a physical control device adhered to the screen, and the revised display in response to inputs from the physical control device.

FIGS. 44A-44C shows several examples of using the Chop Tool for cutting graphics.

FIG. 45 shows several different hand drawn star entries that are recognized by the software of the invention.

### DESCRIPTION OF THE PREFERRED EMBODIMENT

The present invention generally comprises an architecture, which can be high level, for the creation and utilization of hand drawn objects, the designation of functions of the hand drawn objects, and the association of the hand drawn objects with each other and/or with physical devices and/or with text and/or with graphically represented devices to create relationships (contexts) that produce a desired result.

In one aspect, this invention provides an advanced real time system of graphic recognition. User inputs may be entered as hand drawn strokes, and the system may analyze and recognize a wide range of graphic symbols and objects.

In a further aspect, the invention provides a system for imparting functional meanings to graphic symbols and objects, and for selectively changing the functional meanings or transmitting them to other such objects. Such functional meanings could result in enabling a single hand drawn graphic to represent and implement, upon the drawing of such object, a complex machine.

In another aspect, the invention provides a system in which functional graphic objects may be connected or associated on-screen to define and/or control a machine that processes an input to produce a desired output, or to alter the function of one or more of the graphic objects.

In another aspect, the invention provides a system in which functional graphic objects may be connected or associated on-screen to control a non-DSP computer software process, for example, that of a PC.

An additional aspect of the invention is the provision of a system that converts the connected functional graphic objects on-screen to algorithms that carry out the machine functions using programmable digital signal processing devices.

Another aspect of the invention is the provision of an audio or video signal mixing control panel using signal processing elements drawn on-screen and thereafter implemented in software that controls a digital signal processing system.

A further aspect of the invention is the provision of a telephone having a touch screen controller, and the provision of features such as selective call blocking, selective answer message delivery and other premium features upon simple entry of hand drawn functional objects.

The methodology for recognizing hand drawn inputs includes the following general steps:

Conversion:

A hand drawn entry is converted to points. This drawing is converted to a series of individual pixel locations or points on a display. The software of this invention does not need to join these points into an actual line(s) in order to accomplish object recognition. For object recognition purposes, any “line” is theoretical and represents a line which could be drawn between said points. The operating system of the machine that this software is running on, i.e., a PC, generally converts these points to a drawing which, in turn, is presented (shown) on a computer display, i.e., a computer monitor or flat panel display.

Line:

A line can represent a distance between points (“theoretical” line) or be a visible image. According to this invention, for the purposes of object recognition, only the shortest distances between drawn points are needed to be known. These distances are sometimes referred to as “theoretical” lines. They are not visible lines, but measurable distances between points which are used for various object recognition determinations as described herein. A visible line can be utilized as described under “Conversion” above, as an image. Unless specifically noted, the use of “line” in this document refers to a “theoretical” line, namely, the distance between two points or the cumulative distance between multiple numbers of pairs of points. Note: in the case of a “line logic” (discussed later), a theoretical line is used for the purposes of this object's recognition.

Check for Intersecting Hand Drawn Entries:

What has been drawn is analyzed by this software to see if it is near or intersects any existing hand drawn entry (already being displayed on the screen). If such a condition is discovered, there is a check performed by the software to see if anything in proximity to the just-drawn image can be added to the existing image to comprise a recognizable object. If there is no intersection or proximity, then the newly drawn input is considered to be an independent object (for the time being) that needs to be recognized. Note: It can be determined that only intersecting hand drawn entries or hand drawn entries in close proximity that are of the exact same color can be added together or joined to comprise a composite recognizable object. Furthermore, color can be a determining factor for agglomeration. For instance, if a stroke is added to an existing object where the stroke and object are the same color, agglomeration can take place. However, if the added stroke is not the same color as the existing object, agglomeration will not take place if it has been set up that only the agglomeration of same color hand drawn entries can occur.

Stroke Analysis:

The hand drawn entry is analyzed geometrically. The software goes through and looks for recognizable vertices that exceed an angular threshold. The number of vertices that are detected is stored for later use. This process is detailed below. This process is “adaptive”.

Process of Elimination

Deciding as soon as possible what the object is not and then deciding what it could be; or deciding as soon as possible that the current hand drawn object is not a particular object. Depending upon the length, size, and other attributes of the hand drawn object, the software makes decisions about what this object could possibly be. Certain types of recognizable objects are eliminated in this process, but more than one possible object may still exist. If this is not the case, the object is immediately recognized and no further test are conducted.

Analysis

Analyzing the hand drawn object for the types of objects that it “could be”. If the hand drawn object does not fail initial texts, the algorithm can perform further analyses, looking for characteristics which fit various rules that allow the software to assert that the drawn object is a certain shape or form. This same process is repeated over and over, checking to see if the hand drawn object can be determined to be a specific type of object.

More detailed analysis begins if necessary. According to the number of vertices detected, and other attributes, the algorithm tries to make a more accurate determination of what is the hand drawn object. It should be noted again that these algorithms are adaptive. They can take into account results of previous tests, analyze what is being drawn, and in real time they can modify the recognition algorithms described below. That is, this algorithm's recognition parameters are self-modifying.

The algorithm is looking for deviations, but for instance, it does not need to identify four vertices to determine that someone has drawn a rectangle. It may in some cases, but it may not in other cases. Objects can be recognized if they conform strongly enough to certain rules, even if other aspects of the object do not conform or are completely missing.

Once the vertices have been detected, the distances between these vertices are deemed to be “segments”. Each segment can be analyzed for sustained curvature. Then a measurement can be made of how many of the intermediate points that are between the recognized segment's start point and end point are within a tolerable distance from a “theoretical” straight line drawn between the segment's start point and end point. NOTE: A set number of tests is not required for the recognition of every object. In fact, the number of tests required to recognize any given hand drawn object often depends upon the way an object was drawn. This includes the accuracy, speed, proximity, size, etc. of the drawing of that object.

Definition of Terms:

Screen:

The term “screen” is used herein to describe any computer graphics display device. This may include a CRT, a flat panel display or a television, a touch screen with or without a display, or the equivalent of any of these or any other type of device that may be used to enable a user to see a graphic representation of any image that is drawn by any of the input devices described below.

Input Device:

These devices include, but are not limited to: a mouse, trackball, touch pad, touch screen which can utilize a pen or a finger or both, or a device utilizing a sensor tip as described in the patents or patent application referenced above, a device using RF, ultrasonic or infra red or the equivalent of these, a light pen or equivalent, magnetic pads with stylus input devices and any other type of device that accomplished the same purpose as these listed devices.

Points:

A sequential series of locations created by an input device on a screen or touch screen that comprises a hand drawn input. When a touch pen or finger is dragged across a touch screen or a mouse cursor is dragged across a computer monitor screen, the movement is sampled by the computer. This sampling process converts the output of the touch screen or mouse, whichever the case may be, to individual points. These points, in the case of a standard mouse port on a PC or Mac are sampled at a set rate. Therefore the speed at which one drags the mouse or pen will determine how close or how far apart the individual sampled points will be. In other words, if the mouse or pen moves very slowly, there will be more sampled points per inch. If the mouse moves faster, there will be less sampled points per inch. A circuit that is specifically designed to sample the output from a touch screen (not a standard mouse port) could be capable of creating a set density of sampled points regardless of how fast or slow you draw on a touch screen. This software would require a timer.

Default Gap:

A user-defined distance (measured in any unit a user desires, i.e., pixels, millimeters, inches, picas, etc.) that comprises the maximum distance that can exist as a gap in a hand drawn object's defining stroke or strokes. This default gap is also the maximum permissible distance that any hand drawn entry can be from any previously existing hand drawn entry in order for a newly hand drawn entry to be considered part of a previously existing hand drawn entry.

Stroke:

A stroke is the sequence of points that is hand drawn by in input device to depict any object which is to be recognized by the software of this invention.

Adaptiveness:

Adaptive routines are used in the analysis and recognition process. When one or a group of analytical tests are being conducted, the software may automatically alter the parameters of the tests, thereby increasing the opportunity to arrive at a valid identification without substantially increasing the chance for error. The fundamental aspect of adaptiveness is that the software can change the way it tests a hand drawn entry according to its input data, and to ongoing test results.

Draw Threshold or Pixel Threshold or Length Threshold:

This is the minimum length of a distance between two points that is required in order to consider that distance (which can be represented as a “theoretical line”) for analysis. In other words, it is the minimum length between two points that is eligible for a deviation measurement by this software. Another way of defining this threshold is the minimum distance that one must move the mouse, touch pen, finger, etc., along a screen before this algorithm will consider that it has a sufficient length to analyze.

Deviation Threshold (Also Called Bend Threshold):

The deviation threshold is the minimum angle that is required for the software to detect a deviation. A deviation is an angle (a turn) formed in an otherwise straight sequence of points. This deviation threshold is user-definable and is set as a default in this algorithm itself. A typical deviation threshold default would be 35 degrees maximum and 25 degrees minimum. The variation in deviation threshold is explained below.

Segment:

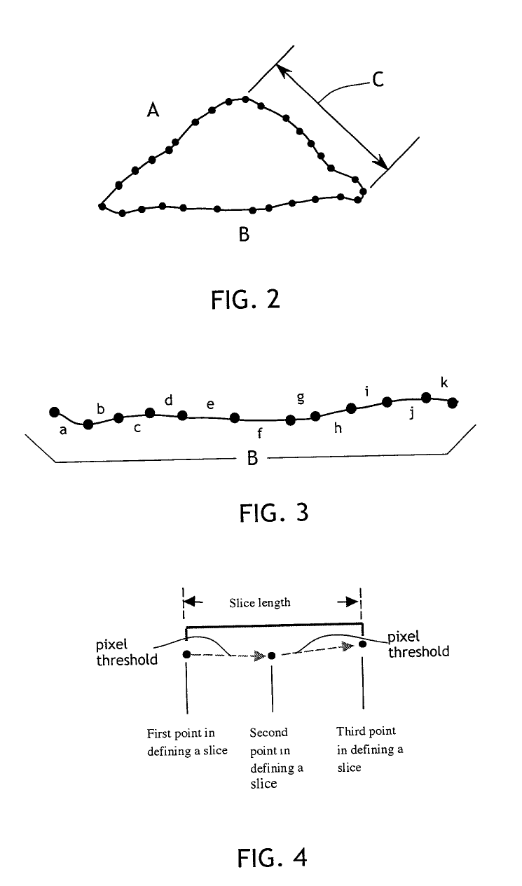

A segment is a collection of originally drawn points in a hand drawn object that exist between any two points that the software designates as two vertices. For example, the triangle shown in FIG. 2 has three segments, labeled A, B and C. So the true length of a segment equals the sum of the distances between the points (represented as the shortest possible distance between each of the points) that lie between two vertices. The true length of a hand drawn entry equals the sum of the individual lengths of each segment that makes up that hand drawn entry. As shown in FIG. 3, the length of segment B is: Σ=a+b+c+d+e+f+g+h+I+j+k.

Slice:

The slice is the selection of points which is used to measure the angle of a drawn stroke and determine if there is any deviation. A slice is a “theoretical” line constructed point-to-point between three adjacent points (each defined by the pixel threshold), which are required to analyze a deviation in a stroke. The distance between the first point and the second point must exceed the “pixel threshold”, defined above. Likewise for the distance between the second point and the third point. These three points comprise a slice. The length is analyzed from point to point accounting for individual displacements of each point along the way, which may not create a perfectly straight “theoretical” line. With regard to FIG. 4, the three points shown are not in a straight line, which is typically the case with a real hand drawn entry. So the total length of the slice is comprised of the distance between point one and point two added to the distance between point two and point three. Note that a slice is a transitory collection of points which are used to measure an angle of deviation. In contrast, “segments” continue to exist in the software as part of a hand drawn object.

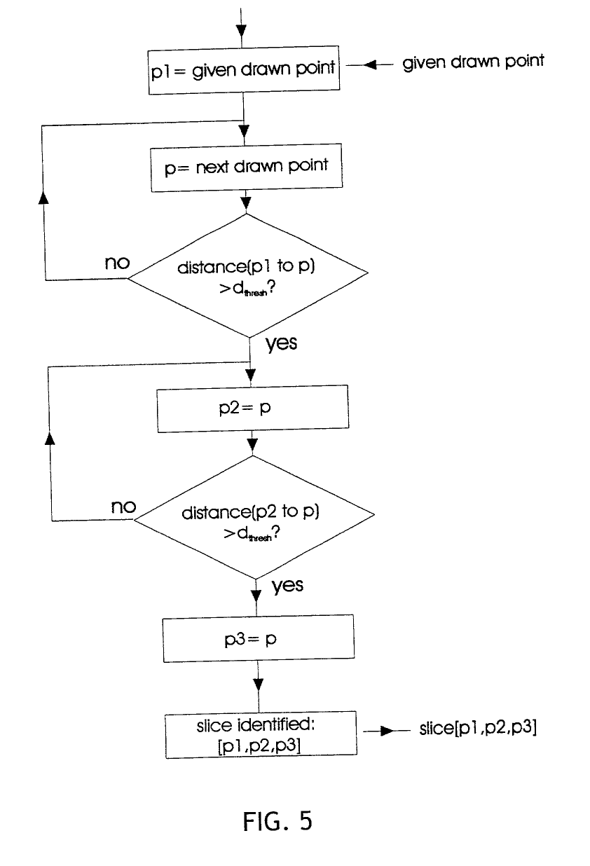

The routine for identifying each slice is depicted in FIG. 5. Note that the three points selected to comprise each slice are spaced apart by a distance greater than the pixel threshold.

Electronic Device:

As used in this document, this term is used to refer to a display screen, a display screen with a touch screen (or its equivalent), a touch screen (or its equivalent), a machine having a display screen (which could be an embedded processor or its equivalent), or a computer (or its equivalent) with a display screen.

Geometric Shape:

This is a hand drawn entry or hand drawn object. Any stroke could be a hand drawn entry. A letter, like an “A” could be a hand drawn entry. Such hand drawn entries may or may not be functional graphic objects.

Info Window.

The term “Info Window” is used in this document to denote a window, menu, notepad or its equivalent, that can be used to enter information to program various parameters of various objects. An Info Window can also be used to enter information to program various actions. There are generally three types of Info Windows: Super Global Info Window, Global Info Window and Individual Info Window.

Functional Graphic Object.

A functional graphic object is any object that serves a purpose of some kind or that can have a purpose by having an additional object added to it, by either intersecting it or being drawn in close proximity to it.

Functional Device.

A functional device is an object that meets the requirements of having four things: aesthetic properties, definition, assignment and action.

Free Drawn (Freehand) Object.

A free drawn object is the figure obtained by moving the input device freely in any direction, as if you were drawing on a piece of paper. Among other things, the result of this drawing can either cause an action, or result in the creation of a functional device, or appear as a visible object on the screen, or remain invisible.

Arrow.

A line which may or may not have one or more short angular lines protruding from its ends. An arrow can be drawn at any angular orientation, at any location, in any color, etc.

Attributes:

Attributes are parameters or other types of defining characteristics; i.e., numbers, text, labels, logics, also including aesthetic properties, definitions, assignments, actions, and function.

Trend.

The “trend” is the cumulative change of angle from the beginning to the end of a sequence of drawn points. For a drawn figure like a perfect circle or a rectangle or triangle, if the hand drawn entry which is drawn to create the figure is joined perfectly in a single stroke, then the trend will always be very close to 360°.

The “trend” is expressed as an angle. A “trend” is the signed (plus or minus) sum of the deviation of the angles of slices within a segment analyzed according to the drawing threshold.

The software calculates two trend values:

Trend for the Entire Stroke:

The whole stroke is analyzed, in other words, all of the points that are drawn in one stroke are analyzed, using slices that are taken serially and sequentially along the stroke. If multiple strokes are used to create a given object, then all of these strokes' points are considered as “one stroke” and analyzed in their entirety. This trend test is primarily for detecting an enclosed object.

Trend for a Segment:

A trend can be determined for each individual segment. This type of trend determines the sustained curvature of a segment. This type of trend is not for the purpose of detecting an enclosed object, but is primarily designed to detect an arc. To measure the trend of a single segment, this test adds up successively the angles point to point in the segment. The test starts with the angle defined by slice 1 and then measures the angle of slices 2, 3, and 4, and so on. The trend sums these signed values for the entire segment, and may reveal significant information about a segment.

For instance, if there is a high trend with a positive sign, this indicates that there is an arc that has been drawn clockwise. If there is a high trend with a negative sign, this indicates an arc drawn counter clockwise.

A trend of zero generally provides little information. For instance, if one drew a zigzag line, the trend of this line (actually a sequence of points) would be very low (close to zero) because each zig trend would tend to cancel out each zag trend. Likewise a generally straight segment (a sequence of points generally drawn in a straight line) has a trend that is also close to zero. But a trend that is high (positive or negative) indicates the drawing of a sequence of points that was in the shape of something like the arc of a circle.

If one draws a circle by proceeding from pen down and then drawing up to the right and then back down and around to the left and then back up to the pen down point, this will result in a roughly 360 degree positive trend. This is approximate because one cannot always draw a mathematically perfect circle with pixels.

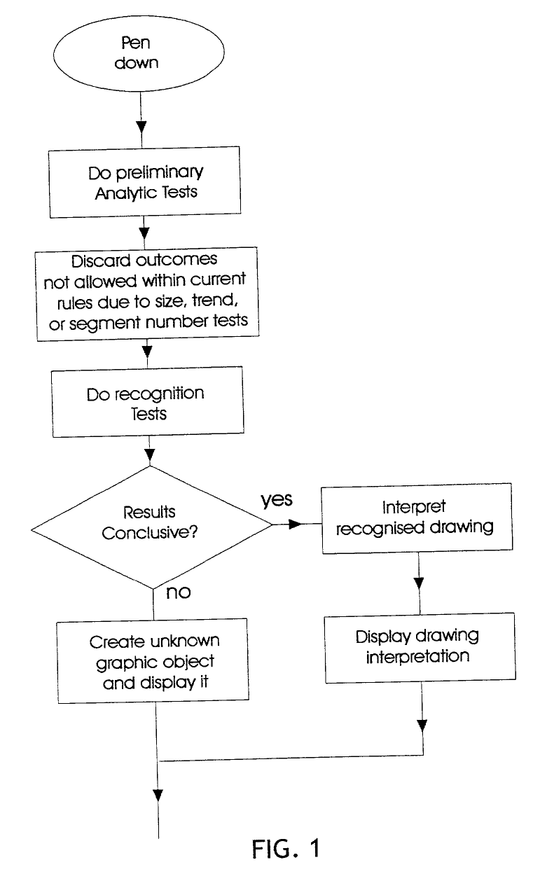

The general approach of the recognition software is depicted in the flow chart of FIG. 1. When a pen down signal is detected, the algorithm begins a battery of preliminary analytic tests in addition to recording the pen stroke for ex post facto analysis. The preliminary results of the tests are reviewed, and outcomes not allowed by rules currently applied regarding size, trend, or segment number, are eliminated. Recognition tests are then carried out, and, if the results are conclusive, the drawn object is identified and the software redraws the object geometrically perfectly at the location of the pen stroke on the screen. If the preliminary results are not conclusive, the software displays the unknown object at the location it was drawn. the remaining analytical tests are run, and the results are surveyed to determine if they are conclusive. If so, the object is identified and machine drawn on screen. This process may be reiterated a plurality of times, until object identification is achieved or a determination of no identification is obtained.

Vertex Analysis:

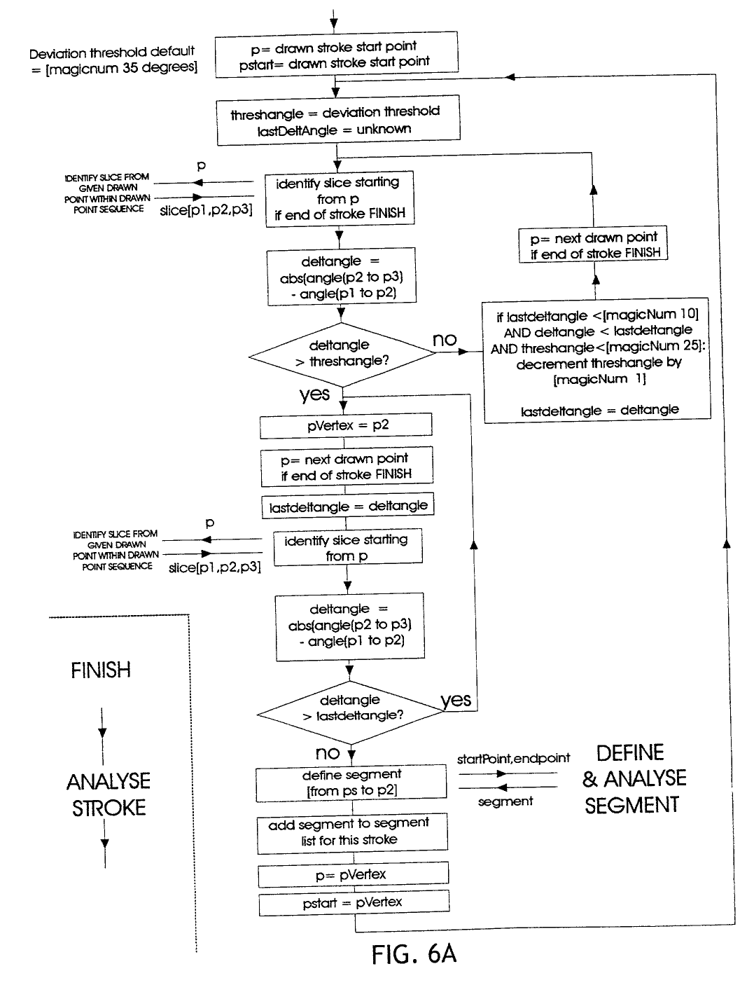

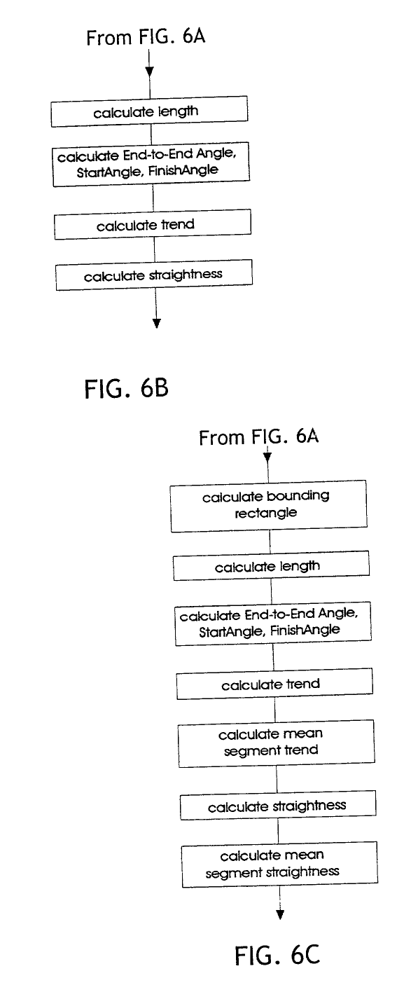

The software routines for detecting deviation, identifying vertices, and defining segments begins with identification of slices of a stroke, as shown in FIG. 5. At any given drawn point p₁, the routine looks at the next drawn point p₂, and determines if the distance between the two points is greater than a threshold length (the pixel length). If it is greater, the system stores p₂ and repeats the process to find p₃. The values of p₁-p₃ for each slice are stored, and fed to the routine of FIG. 6A.

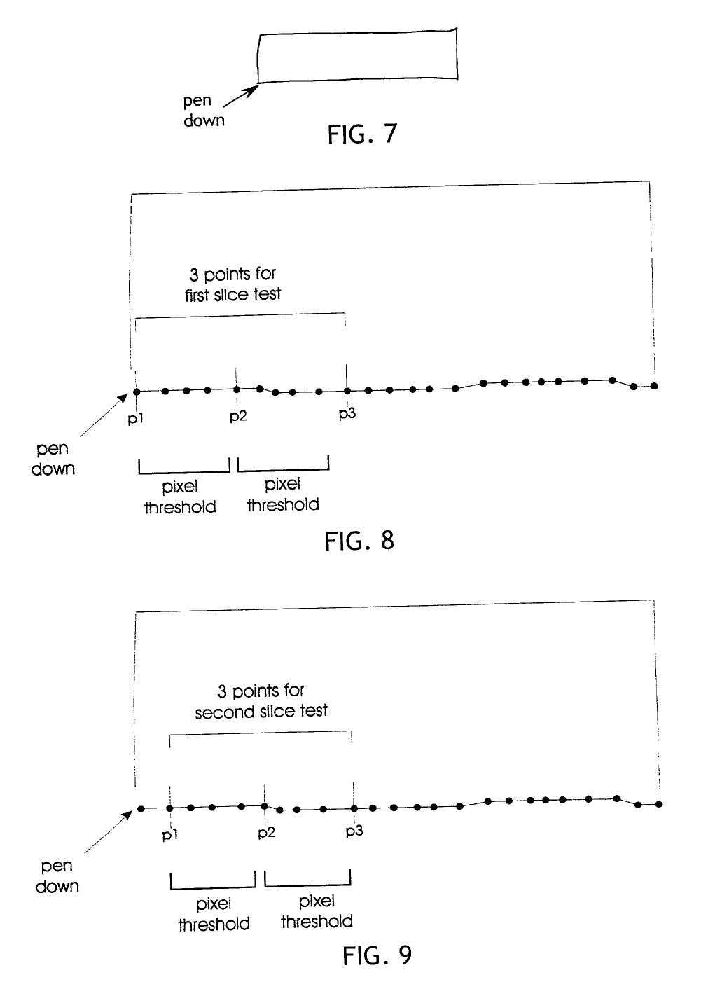

An example of the implementation of the routine of FIG. 6 is provided with regard to FIGS. 7-9, in which a hand drawn object (a rectangle) is analyzed. The slice data derived in the routine of FIG. 5 are used to calculated a deltangle value for each trio of points that define a slice. The deltangle value is compared to a current value for the threshold value. If the deltangle does not exceed the threshold angle value, and the depicted parameters are met, the threshold angle is decremented by one and the routine goes to the next drawn point. (Note that this is one example of adaptive behavior of the software.) If the threshold angle is exceeded, the midpoint of the slice is saved as P_{Vertex}, and the next drawn point is taken up. The routine defines segments between serially adjacent vertices, and stores this data.

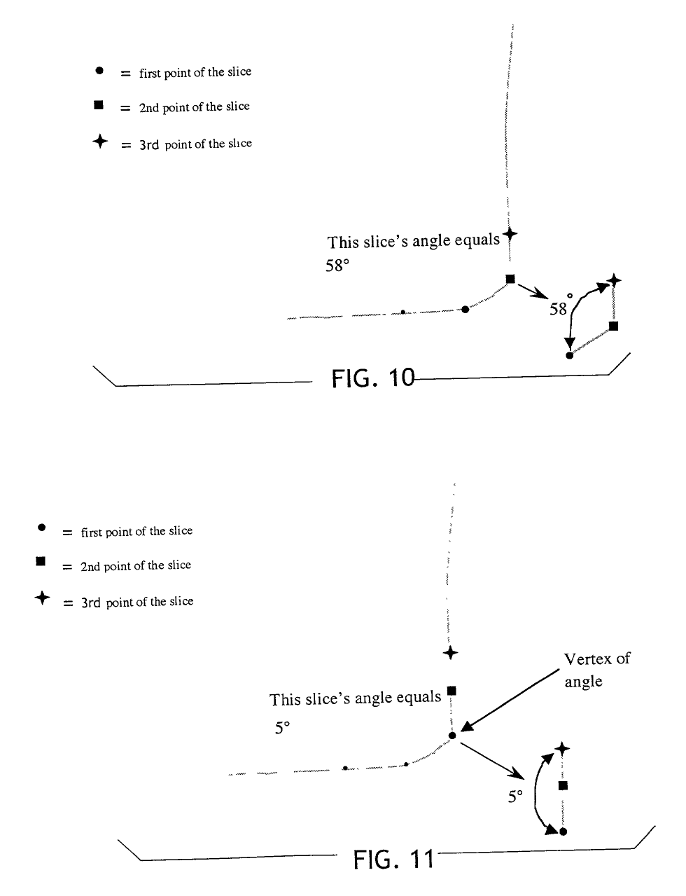

As shown in FIGS. 10 and 11, a vertex determination is made if the slice angle (current deltangle) exceeds the current threshold angle, AND the current deltangle value is less than the previous deltangle value. This latter factor indicates that a region of maximum curvature has been detected. Note that the slice of FIG. 10 has an angle of 58°, and the subsequent slice (FIG. 11) has a slice angle of 5°, indicating that the software steps have iterated along the stroke past the region of maximum angle, which is at (or close to) the midpoint of the slice of FIG. 10. Therefore, the software places the vertex at the midpoint of the slice of FIG. 10. The process continues until all slices of the stroke have been processed, and all vertices determined. (Note that the number of vertices detected may not equal the number of vertices of the geometric shape that was intended to be drawn.)

The segment data is used in a further routine, shown in FIG. 6B, to define and analyze segments. The length of each segment is calculated, as well as the end-to-end angle, the start angle, finish angle, the trend of the segment, and the straightness (sustained curvature). These values are used to detect characteristics that are determinants of object shape.

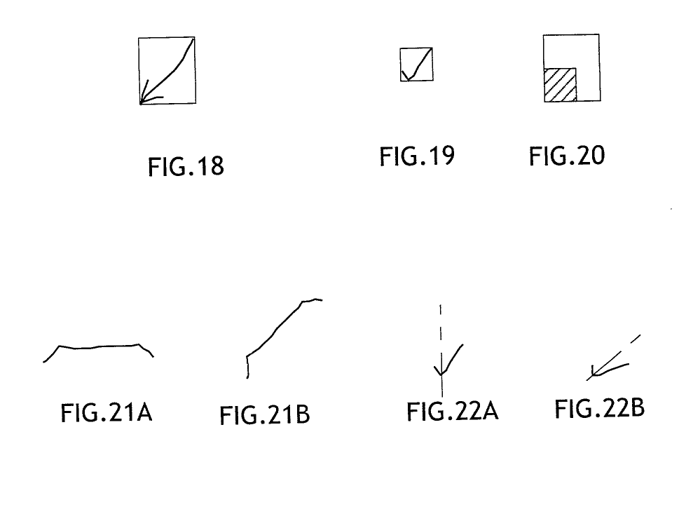

When the routine reaches the end of the stroke, it goes to Finish, and an Analyse Stroke routine, shown in FIG. 6C. This routine calculates a minimum size bounding rectangle for a stroke (shown for example in FIGS. 18 and 19), and also calculates factors such as stroke length, the end-to-end angle, the start angle, finish angle, and stroke trend. It also calculates the mean of the segment trends of the stroke, the straightness, and the mean of the segment straightness of the stroke. These values are also used to detect characteristics that are determinants of object shape.

NOTE: It is in this process that the first type of adaptiveness comes to play.

The process described above may be reiterated until the entire hand drawn sequence of points (hand drawn entry) is analyzed, all vertices are recognized, and the calculated parameters are stored. The number of vertices detected may be a strong indication of the type of geometric shape that has been drawn, or intended to be drawn. However, detecting four vertices for a rectangle, or three for a triangle, or five for a folder is often not necessary. For example, the recognition of two vertices may indicate a drawn triangle or a drawn rectangle, depending upon the nature of the detected vertices.

Wide Pen Test

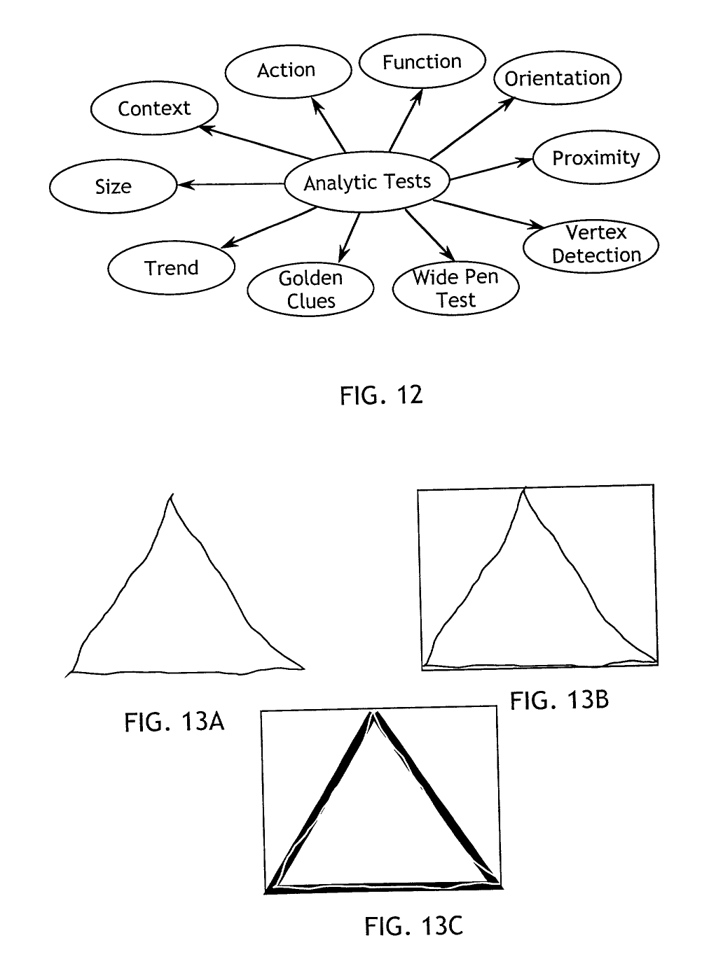

With regard to FIG. 12, the battery of analytic tests applied to a hand drawn entry includes not only the angular deviation, vertex detection and segment identification, and trends, but also the wide pen test. As shown in FIGS. 13A-13C, a hand drawn shape such as a triangle may be preliminarily identified by its three vertices, but this identification may not be completely assured. As a further test, the invention provides the wide pen test.

The wide pen approach is used as a quick method to detect hand drawn objects that are relatively close to the objects that they are intended to be. Being relatively close means that the object(s) are drawn in such a manner that their resulting points more closely match one type of object's geometry than another. The use of this approach is not limited to these types of “more accurately drawn” objects, but the wide pen approach can be very effective to immediately recognize many hand drawn objects. One tool that this algorithm employs in implementing this wide pen approach is the use of an invisible bounding rectangle, as shown in visible form in FIG. 13B. The algorithm considers the object that was hand drawn (after it has been converted into a series of points) and then locates the topmost, bottommost, leftmost and rightmost points of that object. Then the software constructs the rectangle in such a way that the inside theoretical line (this line is not visible to a user of this invention) of each side of the rectangle just touches each of these points. Thereafter, the algorithm places in the rectangle a trial object that is most likely to match the drawn object. (This is also invisible to a user of this invention.) For example, it could be that the determination of three vertices would likely cause the selection of a triangle as a trial object (FIG. 13C). However, the vertices test is not required for the use of the Wide Pen test. The trial object is drawn with a wide pen, on the order of 3-6 pixels in width, to permit some latitude in the natural variations of the hand drawn figure with respect to the more exact, computer drawn figure. For clarity, the hand drawn figure is shown in a white line superimposed on the wide pen test object in FIG. 13C. Note: in the case where a test for vertices has not been conducted, various trial objects can be utilized until one is found that matches the desired percent required for successful recognition, as described below.

Thereafter, the algorithm calculates the number of points in the hand drawn entry that lie within the wide “line” of the machine drawn figure. If the degree of coincidence is greater than a predetermined threshold, the hand drawn object is identified as the trial object. The coincidence threshold may be set at 80%, for example, so that if more than 20% of the points of the object lie outside the wide “line” of the trial object, the hand drawn object is deemed not to be that trial object. The coincidence threshold may be varied as one of the adaptive routines that are run, if identification is not obtained in a first or subsequent trial. Likewise, the width of the “line” of the trial object may be increased by one or more pixels as one of the adaptive routines that are run, if identification is not obtained in a first or subsequent trial. Note that the width is increased at the inside of the “line”, so that the computer drawn trial object does not overlap the bounding rectangle.

The wide pen test may be run with any object shape that is appropriate, including ellipses and circles, and open curved shapes.

Golden Clues

A further test in the battery of analytical routines provided by the invention and shown in FIG. 12 is the golden clue approach. The “golden clue” approach is based upon an observed statistical analysis of how people tend to draw objects in real time. This “golden clue” approach is predicated upon the premise that when any object is hand drawn, certain parts of it are likely to be more accurately drawn that other parts. In general, the first part of a simple object is more likely to be drawn accurately than the rest of the object. An exception to this rule is noted for objects that are more complex and may contain a graphic detail that is a primary consideration for the distinction of that object. This is discussed below. In the few milliseconds it usually takes to hand draw a small graphic object, the care that is taken to achieve accuracy often falls off almost immediately and only the very beginning of the object is generally accurately drawn. This often is limited to the first and possibly the second vertex, with the first usually being quite a bit more accurate than the second. In other words, the likeness of what the person is drawing to a perfect image or example of what is being hand drawn can decrease very rapidly as the drawing proceeds. This phenomenon involves the habits and intuitive methods that people use when they draw on a tablet of paper with a pencil or pen, and these habits are applied when drawing with a touch pen or finger on a touch screen. To some extent these principles also hold true when using a mouse to “hand draw” on a computer monitor. The difficulty of maneuvering the mouse does alter to some extent a person's natural drawing style, but does not eliminate it.

When a person draws a rectangle, for instance, the first right angle tends to be fairly accurate. It tends to be more of a right angle than any of the following right angles required for drawing a rectangle. The second right angle is much less likely to be drawn as a perfect or near perfect right angle and the third right angle and fourth right angles are even less likely. In fact, what people often do when hand drawing a rectangle is to make the third and fourth right angles curved strokes. Also, it is very common to overlap the end of the hand drawn stroke used to draw a rectangle with the beginning of the stroke the start point of the hand drawn rectangle. This overlap can also cause confusion for a recognition algorithm

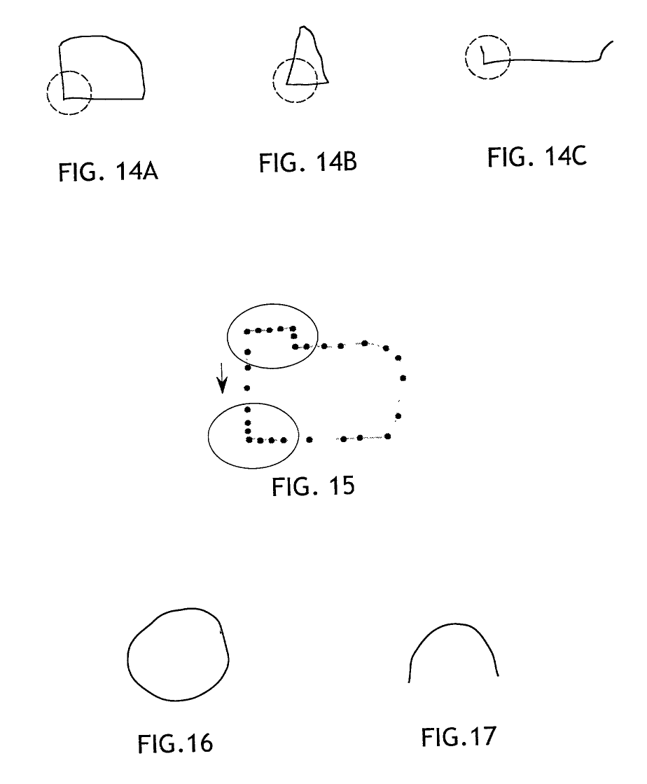

With regard to FIGS. 14A-14C, there is shown representative rectangle, triangle, and bracket objects, respectively, that are hand drawn in a casual manner that may evade easy recognition. The dashed circles indicate the more accurate hand drawn angles which occur at the beginning of each drawing. As the drawing continues, strokes tend to get more rounded as the desire to quickly execute the drawing leads to shortcuts and diminished care in the accuracy of the drawing.

The use of “golden clues” is a way that this object recognition algorithm(s) can be adapted to cope with the above described phenomenon. This software uses “golden clues” to weight the probabilities of certain vertices being accurate indications of a certain type of object. With reference to FIG. 14A, the “golden clue” is that the person hand drew two strokes that created a near perfect or easily recognized right angle. The fact that this is the first vertex that the software detected makes this a “golden clue”, because this right angle has the highest probability of being what the person who drew the object intended to draw. So, this first right angle (in the dashed circle) gets the highest score. It may be weighted more than the other angles that are drawn in the rest of the object. Accordingly, the last angle drawn in this rectangle gets the lowest score, because statistically it is least likely to be accurately drawn, and it is given the least weight in the algorithm's decision-making process.

Clearly, the golden clue approach depends on the knowledge of which portion of the object has been drawn first. This is an essential part of the algorithm's ability to utilize “golden clues”. In fact, without the ability to “know” where the first pen touch is, there would be no way to “know” what angles were drawn first, second, or whatever. So, part of this algorithm detects the first pen down and use it to determine the direction of the first and subsequent strokes in the hand drawing of an image. In contrast, prior art pattern and image recognition systems and software take the whole image at once that is being recognized and try to figure out what it is.

Furthermore, this software can store the first pen down location and the direction of the stroke(s) so that later it can analyze the object and look for “golden clues”. A significant point here is that this “golden clue” approach is not limited only to real time drawing Real time drawing can be “captured” (including the all-important first pen down and the direction of the stroke(s) and the rate at which the object was drawn) and then analyzed later just as effectively as it can be analyzed when the object(s) are drawn in real time. This software has the ability to save hand drawn images with the following important information for non real time analysis:

a. Which point in the hand drawing comprises the first pen down.

b. The direction of the stroke after the first pen down.

c. The speed of the stroke, i.e., does it speed up and if so, where and when and how much. In other words, the entire rate of hand drawing can be stored and later analyzed and converted to a detailed graph if needed.

d. If a hand drawn object was created by using multiple strokes, then items a, b and c above will be stored for each additional stroke.

The reason this information is known is that this software stores all of the points that a person uses to draw an object in the order that these points were used. These stored data insure that the above information from a to c will be know for every object that is hand drawn.

Golden Clues can be used to alter the decisions resulting from various analyses of a given hand drawn object. One example of this would be to modify the parameters of the wide pen test. That is, if one Golden Clue is found, then the number of points of a given hand drawn object that can lie outside the surface area of a Wide Pen “line” (see Wide Pen discussion above) may be increased by a certain percentage.

The exact equation used for a given hand drawn object, i.e., a star verses a rectangle or a folder verses a check mark, changes for each hand drawn object. This equation is optimized based upon extensive recognition testing of each object. Furthermore, the percentage of alteration from one or more Golden Clues can be user-defined or user-adjusted to better suit the drawing style of that user. Thus the overall approach to applying Golden Clues to the Wide Pen Test is defined as: The coincidence threshold for the number of points of a hand drawn object that must be within the Wide Pen stroke varies according to the number of Golden Clues that are detected.

The following is an example of this rule for a rectangle. A Golden Clue for a rectangle is finding a 90 degree angle (or an angle that is within a set tolerance or threshold of 90 degrees) THAT is preceded by a vertical stroke of a minimum length (that meets the minimum “pixel threshold” parameter) AND is followed by a horizontal stroke (that meets the minimum “pixel threshold” parameter) THAT is within a certain tolerance of being a horizontal line (as compared to a theoretical perfect horizontal line reference). If one valid Golden Clue is obtained, this may increase the amount of tolerated errors (the coincidence threshold). As an example, assume that the error limit for the Wide Pen tolerance with no Golden Clues is the number of points in the hand drawn entry divided by the number six. If more than this number of the hand drawn entry's points are outside the surface area of the Wide Pen stroke” then the hand drawn object fails the Wide Pen test.

If there are 1000 points detected in a given hand drawn object, then 1000 divided by 6=166.66. Thus, if more than 167 points lie outside the Wide Pen “line”, then the object fails the Wide Pen test. The detection of Golden Clues can be used to modify this equation. One way that this can be done is as follows: “The number of Golden Clues that are detected are subtracted from the divisor number (in this case six)”. So, if one Golden Clue is detected, then the divisor is reduced to 5. Therefore, instead of 167 being the maximum threshold, the new threshold becomes 1000/5=200. If two Golden Clues are detected, then the divisor is reduced to 4 and the maximum threshold becomes 250.

Another approach for the use of Golden Clues is to take into account the fact that the first Golden Clue has the highest probability of being the most accurate part of the drawing. Thus, the Golden Clues themselves can be weighted. For instance, the first Golden Clue may carry 55% or 60% of the total value for all Golden Clues for a given hand drawn object. The second Golden Clue may carry a value of 25% and the third Golden Clue may carry a value of 10%. NOTE: Generally three Golden Clues are enough to define most objects, although this is not a limiting factor nor an absolute rule. The weighted values according to the order of the Golden Clue would then further modify that Golden Clue's effect on altering the divisor as used for the Wide Pen calculation. Furthermore, the weighting of Golden Clues will vary according to each different type of hand drawn entry, i.e., a rectangle, a star, a folder, etc.

Assuming that the first vertex that is drawn for any given object is likely to be the best drawn, this first vertex can be weighted more heavily in the decision making process of this algorithm to decide what an object is. Likewise, the second vertex may be weighted more heavily that the third vertex, assuming that the second vertex would likely be the second most accurate of the vertexes in a given hand drawn image.

Returning to the rectangle example of FIG. 14A, if the first vertex is close to 90 degrees, AND if it's within the range of acceptable angles to be recognized as a 90 degree angle, AND the segment prior to this 90 degree angle is within an acceptable tolerance for being vertical, AND if the second segment (the segment following the first 90 degree angle) is within an acceptable tolerance for being horizontal, THEN this first vertex would qualify for being a vertex of a rectangle and not a triangle. It could still be a vertex for a bracket object, but a bracket would be clearly distinguished from a rectangle because its “trend” (the value that determines how “closed” an object is) would be basically zero, while the “trend” of a closed rectangle would be about 360°.

Thus this first vertex, as described above, is a “golden clue”. It's existence added to the “trend” of the object can be used to rule out what the object is not. Knowing the trend of an object can eliminate the need to carry out certain further tests for the likelihood that a hand drawn object will be certain types of objects. In the example above, the “golden clue” +the “trend” of the rectangle rule out the possibility that the object could be either a triangle or a bracket. It also rules out the possibility that the object could be a circle or an ellipse. (However, it doesn't rule out the possibility that the object could be, e.g., a folder.)

The folder shape, shown in FIG. 15, is comprised of a rectangle having a tab protruding from an upper edge thereof. The points shown on the theoretical line that comprise the folder shape are indicative of the placement and spacing of actual points derived from the pen or mouse input, although in reality there will be a far greater number of such points. The golden clue test may provide more than one indication of the identification of this object. First, the spacing of the points that define the object is not uniform, and the closer spacing of points at the lower left vertex and the upper tab portions (circled in FIG. 15) are indications that the pen or mouse was moving more slowly when these portions were drawn, which is a likely indication that more care was exercised in creating these portions. Greater care in making these portions, in turn, is an indication that they are most important in defining the object. Thus the spacing of the points of these two features may be weighted to enhance their importance in the identification scheme.

Furthermore, as described above, the rather precise drawing of the lower left vertex (the first vertex) is an indication of the user drawing either a rectangle or a folder object, these being the only two objects in the given examples that have this feature. Thus this one golden clue may result in the elimination of many candidate shapes in the recognition process. (Clearly other objects may have an orthogonal lower left vertex.) The mere presence of the tab portion is a golden clue, and in combination with the lower left vertex, may result in a correct identification of a folder. In addition, the tab portion includes two right angles in close proximity, and this feature may comprise a golden clue, since this combination of right angles in close proximity is not found in many other shapes. In addition, the trend of these two right angles is close to zero, due to the fact that they turn in opposite directions, and this feature may also comprise a golden clue. The tab portion actually comprises three right angles in close proximity, if the vertex at the upper left is included, and this combination may comprise a golden clue.

These golden clues may be weighted in accordance with empirical data regarding the drawing habits of most users. For example, the presence of the tab portion may be highly weighted, due to its distinctiveness, such as 70% of the weight, and the first precise right angle may be weighted as 30%, and the recognition of three right angles in the object may be weighted as 30%. A composite score may be developed from these factors, and other similar factors, to lead to a possible identification of the object.

The analytic tests shown in FIG. 12 also include trend, which is defined as the cumulative change of angle from the beginning to the end of a sequence of drawn points. The trend is the signed sum of the angular change, which is useful in identifying closed shapes in particular. For example, as shown in FIG. 16, a hand drawn closed loop has a trend of approximately 360°. Although a rectangle or folder or triangle also have trends of about 360°, the determination of this trend combined with the lack of any distinguishable vertex or straight segment provides a very high likelihood of identification as a circle. Likewise, the arch shape of FIG. 17 has a trend of approximately 180°, which clearly distinguishes over and eliminates such shapes as triangle, rectangle, folder, and circle.

Size

A further analytic test of FIG. 12 for object recognition is the size of the drawn object. For many objects, this may be the first test. Some hand drawn objects may have size limits; i.e., either they cannot exceed a maximum size or must exceed a minimum size. Therefore, determining that a given hand drawn object is larger or smaller than a given size threshold may eliminate that hand drawn object from being considered to be any object which requires such a size threshold. As shown in FIGS. 18 and 19, the drawings of an arrow and a check mark (tic), respectively, do not differ substantially in orientation, trend, or other tests described previously. However, an arrow is typically drawn larger than a check mark, since an arrow is usually drawn between objects, whereas a tic is drawn adjacent to a single object. This size differential may be employed to distinguish the two objects. This test may be carried out by generating a bounding rectangle for each object, and determining the size of the bounding rectangle or size could be determined by line length analysis without a bounding rectangle. As shown in the juxtaposition of FIG. 20, the bounding rectangle of the check mark is approximately one-half the size of the bounding rectangle of the arrow, and this differential is more than sufficient to distinguish the two drawn objects.

More generally, the software can utilize user-defined size limits for the recognition of objects. In other words, certain types of objects can be specified to be no larger than a certain dimension. If they are larger than this dimension, they will not be recognized. Once a size is set for an object (i.e. a triangle) so it cannot be recognized if it is bigger than a this set size, then any hand drawn triangle that is larger than this set size is not ever tested for being a triangle. There are many benefits to this feature, such as:

1. Check marks are typically drawn small, and limiting the size of a check mark makes sense. The software can have a maximum size set for a check mark (tic). If an image is drawn that is larger than this maximum size, it will not be tested for being a check mark. If the object has very similar properties to a check mark, but it exceeds the size limitation, it is likely to be an arrow.

2. The speed of recognition depends partly on what can be quickly discounted with the minimum amount of processing. Assigning size requirements to hand drawn objects aids this process.

3. With size limitations set in the software, users can actually draw objects quicker because they get used to certain objects having to be less than a certain size. Certainly drawing smaller objects is generally faster than drawing larger objects.

Also, there is a psychological advantage here as well. Since the size maximums are user-definable, users can set up the maximum sizes of recognizable objects to suit their own drawing styles. This means that the drawing of these objects becomes more intuitive for them and they do not have to draw objects extremely carefully so that they may be recognized more easily.

Direction

The direction of a stroke(s) that is used to draw an object can be used as a determining factor for object recognition. Returning to the arrow and check mark examples (see FIGS. 18 and 19), these objects may be distinguished by the direction of the pen stroke used to draw them. For example, one typically draws a check mark by starting its stroke at the lower end of the check mark, then drawing down a little to create the short end of the check mark and then back up to create the stem of the check mark. Likewise, one typically draws a small arrow by starting at the top end of the arrow stem (this is the opposite end that you started to draw the check mark) and drawing downward and thereafter drawing the arrowhead on the lower end of the stem. This differential in drawing direction may be used to distinguish the drawing of a small arrow from a check mark.

Orientation

A further test indicated in FIG. 12 is the orientation of the drawn object, which may be determined primarily by the deviation test. For example, a bracket as drawn in FIG. 21A may be recognized by the algorithm as a bracket because only relatively horizontal or vertically drawn brackets will be recognized. Therefore drawing angled strokes of any kind, as in FIG. 21B will never be mistakenly recognized as brackets. In other words, brackets must only be drawn horizontally (within a horizontal threshold) or vertically (within a vertical threshold) to be recognized. Another example could be check marks or tics. A check mark or tic may be recognized only when it is drawn upright; i.e., the bisector (broken line) of the check mark angle is substantially vertical, as in FIG. 22A. Other types of check marks (tics) drawn outside a required orientation threshold for a check mark, such as the check mark of FIG. 22B, will not be recognized as a check mark.

Another example of the use of orientation is to ensure the recognition of certain multiple stroke objects, like a plus sign. The algorithm may only look for two small strokes that are horizontal and vertical and intersecting (within certain thresholds for recognition consideration). So, non-orthogonal short strokes will not be considered to be recognized as a plus sign. Note: In the case of this plus example, both size and orientation may being used to narrow the scope of possible objects that can be recognized as a plus sign.

Context

In addition to size and orientation, the context of a hand drawn object can help determine its recognition. Hand drawn objects can have contexts assigned to them. There are three types of contexts that will be mentioned here, but there can be others.

Location (Proximity) Context.

An example of location context is drawing objects inside a menu or inside a certain type of folder icon or near a certain type of graphic or near a physical device, like a knob or joystick. The hand drawn object must be within a certain proximity or distance to another object in order to be associated with it or affect it. It should also be noted that this proximity factor can be adaptive. As an example, if one draws an object of a certain size, i.e., 100 by 200 pixels, and this object is within a distance of 15 pixels (these numbers are user-definable) to an existing graphic object, then this hand drawn object to will be automatically associated with that object. This association may take many forms.

Some examples of proximity context are:

(a) The hand drawn object, that is within the proximity tolerance of a second object, becomes part of the second object and changes its recognition to being a new object. For instance, a tab drawn at the upper edge of a rectangle may be agglomerated thereto to become a folder object. Or, the acute angle drawn at the end of a line may be agglomerated thereto to define an arrow.

(b) The hand drawn object that is within the proximity tolerance of a second object is automatically assigned to that object's signal path.

(c) The hand drawn object that is within the proximity tolerance of a second object, becomes part of the operational controls of the second object.

(d) The hand drawn object that is within the proximity tolerance of a second object is automatically grouped to that object.

As an example of proximity grouping, one may assign one or more locations to a hand drawn object. Assume a rectangle is assigned multiple locations, including various menus labeled X and Z. Assume an ellipse is assigned to menus A and B, but not X and Z. Therefore any hand drawn object in menu X and Z cannot be an ellipse. Likewise, only hand drawn objects that are assigned to menus X and Z can be considered for recognition as a rectangle in accordance with this proximity feature.

Function Context.

An example of function context is a volume control for an audio channel or brightness control for an equalizer. Assume there is a knob that has an assigned function and an arrow and a check mark each with their own unique assigned functions. If the arrow does not have a function that can be applied to the function of the knob, but the check mark does have a function that can be applied to the knob, then the recognition software (utilizing “Function” as part of its recognition criteria) will recognize the check mark, but not the arrow, when the check mark is drawn next to the knob. To continue this example, assume the knob's function is volume control of an audio signal, and the arrow's function is to apply a color (e.g., blue), and the check mark's function is setting a volume threshold. Since “making something more of the color blue” doesn't affect volume, the check mark would be recognized over the arrow, because the check mark's function applies to volume, and the arrow's function does not apply to volume

Action Context.

An example of an action would be turning something “on” or “off” or grouping a number of selected objects. Like Function context, Action context can be used in the recognition process of hand drawn objects. Note: This invention provides for the use of color to be applied to any hand drawn object to narrow the scope of that object. For instance, a green check mark could equal the action of resizing an object to 50% of its size; a green arrow could equal the action of changing the direction of a physical knob device such that a counterclockwise motion increases the value of the device (rather than decrease it, which would be more typical for such devices). So, if a small arrow were drawn next to a volume knob (of the example provided in the discussion for Function context), it would not be mistaken for a green check mark. This is because the action of a green check mark has no relevance for a physical volume knob, namely, a physical volume knob cannot be decreased in size by 50%. This could only apply to a graphic volume knob. So, the hand drawn green arrow drawn next to the volume knob, would not be mistakenly recognized as a green check mark.

### Hand Drawn Objects as Functional Objects

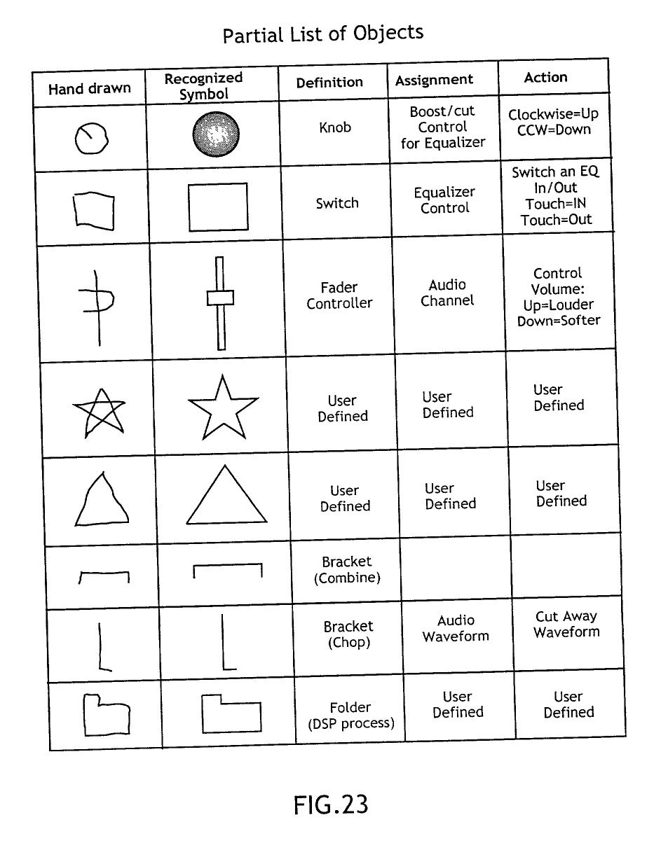

A further major aspect of the invention is the interpretation of the recognized hand drawn objects as symbolic elements that describe functions to be carried out by the software. Although this aspect will be described initially with respect to audio signal processing on a virtual mixing board, comparable to a recording studio control panel, the invention is not limited to such use. With regard to FIG. 23, a few possible object shapes and the functions ascribed thereto are depicted. The circle object with a radial line is designated as a knob which may be used selectively to vary an input quantity. Many input techniques are available for “rotating” the virtual knob. One of these, described in copending application Ser. No. 09/670,610, filed Sep. 26, 2000, comprises the use of a physical knob adhered to the touch screen on which the circle (knob) symbol is drawn. Manipulation of the physical knob enables virtual rotation of the knob to vary the input value. Likewise, the knob may be used, by proper software selection, as a joystick or mouse controller to move a cursor about the touch screen or computer display.

The rectangle object (or, alternatively, a rectangle within a rectangle) is designated to be a switch of any sort, and the actual nature of the switch may be set forth by the user as described below. The fader controller function is symbolized by a small half loop stroke or a small rectangle superimposed over a long vertical line that resembles a fader cap slidably mounted on a track. This function may also be augmented by the use of a real fader cap secured to the touch screen for slidable movement in a direction indicated by the longitudinal extent of the track graphic, as also described in the patent application referenced above. The star shape and triangle shape may embody any function defined by the user, and the horizontal bracket shape is designated to combine or associate the functions of any symbol that falls within the extent of its outer edges. The chop bracket is a vertical stroke with a horizontal tail at the lower end, and the direction of the tail is significant, as discussed below. A folder shape is a rectangle with a tab at the upper edge, and may be drawn as a single stroke or as agglomerated strokes. The folder may be designated to represent a DSP process. Note: The number of objects that can be recognized by this software are not limited to this list in FIG. 23. This list is supplied for discussion purposes only.

User-Defined Functions and/or Actions for Free Drawn Objects

A. Info Windows

There are generally three types of Info Windows: Super Global Info Window, Global Info Window and Individual Info Window. The Super Global Window applies to all hand drawn objects (switch, star, fader, ellipse, etc.). The Super Global Info Window for hand drawn objects can be used to set parameters that apply to all possible hand drawn objects. An example of such a parameter would be the thickness of the visible line displayed on a screen for every object. A Global Info Window is used to set parameters for one defined type of hand drawn object, i.e., all stars, or all faders, or all ellipses, etc. The Global Info Window will affect every object of that type that is drawn. For example, the Global Info Window for the object “arrow” will affect every arrow that is drawn. The Global Info Window for the object “triangle” will affect every triangle that is drawn. The settings of the Global Info Window become the default parameters for every object covered by the Global Info Window. Furthermore, many things like conditions, functions and contexts, for the drawing of this object can also be assigned. For example, the maximum size that a check mark could be drawn, in order to be recognized, could be set in the Global Info Window for the object “check mark”.

Each individual hand drawn object can additionally have its own unique Individual Info Window. What is different about this Info Window is that it is specific to just one instance of a hand drawn object, that is, an object that is drawn in a specific place on a display, even at a specific time. In this Info Window further things, like contexts, functions and conditions can be specified that only apply to this one object whose Info Window you are viewing.

Designating a “Function” for a Hand Drawn Object

To designate a function for a hand drawn object, four things need to be known or determined about that object:

(1) Aesthetic Properties

These properties include the shape of the object, the color of the object, and the location of the object The selection of “ink” determines the color of the object. Where the object is drawn determines the location (the X and Y coordinates) for the object.

(2) Definition

Definition of an object is the operation or device that the hand drawn object represent, i.e., a folder, a fader, a knob, a switch, etc.

(3) Assignment

Assignment is the application of the operation of the object to a specific use. For instance, an object defined as a knob may be applied to control a boost/cut control for an equalizer, or to control the amount of saturation for the color blue, etc.

(4) Action

Action specifies the manner in which the assignment is carried out. For instance a knob (Definition) that is a boost/cut control for an equalizer (Assignment) can increase the amount of boost/cut when the knob is turned clockwise and decrease the amount of boost/cut when the knob is turned counter clockwise. This is the action of this knob.

These four parameters comprise a functional device.

If a hand drawn object has aesthetic properties, a definition, an assignment and an action, it can be a functional device.

Using a Chart in an Info Window for the Designation of a Functional Device:

Referring to FIG. 23, this chart may comprise a page from an Info Window where each of the four parameters described above can be user-defined. The first parameter, of course, is automatically defined when an object is hand drawn on a display and recognized. The rest of the parameters can be determined by various methods.

For example, a user may access the Info Window page of FIG. 23 and enter a definition, assignment and action for any given hand drawn object by the following methods: (1) typing in the name of such function, (2) drawing an arrow from the picture of the hand drawn object to another object that has the definition, assignment and action that is desired to be the function of that object, (3) drawing graphics under the definition, assignment and action columns that equal the function that is desired to be programmed for a certain hand drawn object; (4) choosing inputs from menu selections, and (5) verbal commands or statements.

(1) Typing the Name of a Definition, Assignment and Action into an Info Window Page.

Consider the circle in FIG. 23. If a user wished to draw a circle to be defined as a knob, the word “knob” could be typed in the “Definition” column of the Super Global Info Window for all hand drawn objects. If the user wanted a blue circle to equal a knob, the user may first draw a blue circle under the hand drawn column and then type “knob” under the “Definition” column of the info window page. Next a word or phrase that determines the assignment for this knob would be typed in the “assignment” column. The phrase, “Boost/Cut control for an equalizer” could be typed in this column. Finally, the action for this boost/cut EQ knob could be typed in the “Action” column. The word: “clockwise”, could be typed or the phrase: “increase the knob's value with a clockwise turn”.

(2) Arrows and Arrow Logics.

An arrow with the following logic could be used to assign a function to the circle as pictured in FIG. 23. This arrow logic may be: “the function of any object that the arrow is drawn from will be assigned to any object that the arrow is pointing to”. So, drawing such an arrow from an object that is functioning as a knob (i.e., drawing an arrow from a physical knob adhered to a display screen) to the circle as pictured in the column labeled “Hand Drawn” in FIG. 23 will do the following. It will designate this hand drawn circle in this info window page as a “knob”, that could also have the same assignment and action of the knob that the arrow was drawn from.

(3) Drawing Graphics under the Definition, Assignment and Action Columns of an Info Window Page.

Rather than typing in the names of definitions, assignments and actions, these characteristics can be entered by drawing graphics that have been designated to equal one or more specific properties for any definition, assignment and/or action.

(4) Choosing Inputs from Menus Selections.

An example of this approach would be going to a pull down menu or its equivalent and selecting definition, assignment and action parameters from a list of available choices.

(5) Verbal Commands and/or Statements.

Utilizing any number of different types of voice recognition software, a user of this software could speak the name of any appropriate parameter for a definition, assignment and/or action and have this parameter appear in the info window page, described above.

Designating a Hand Drawn Object as Being a Device Without Specifying a Definition, Assignment and Action.

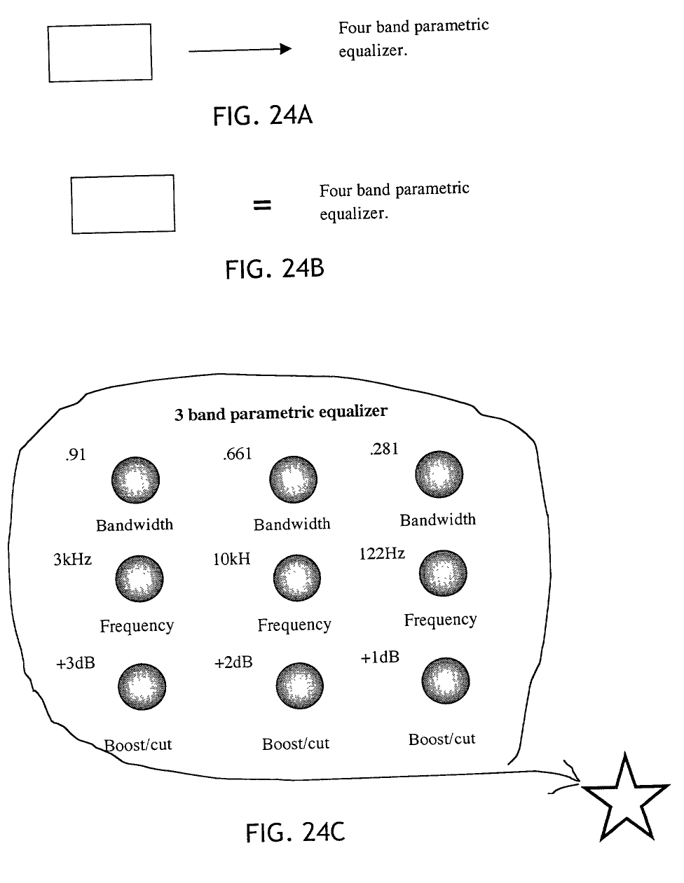

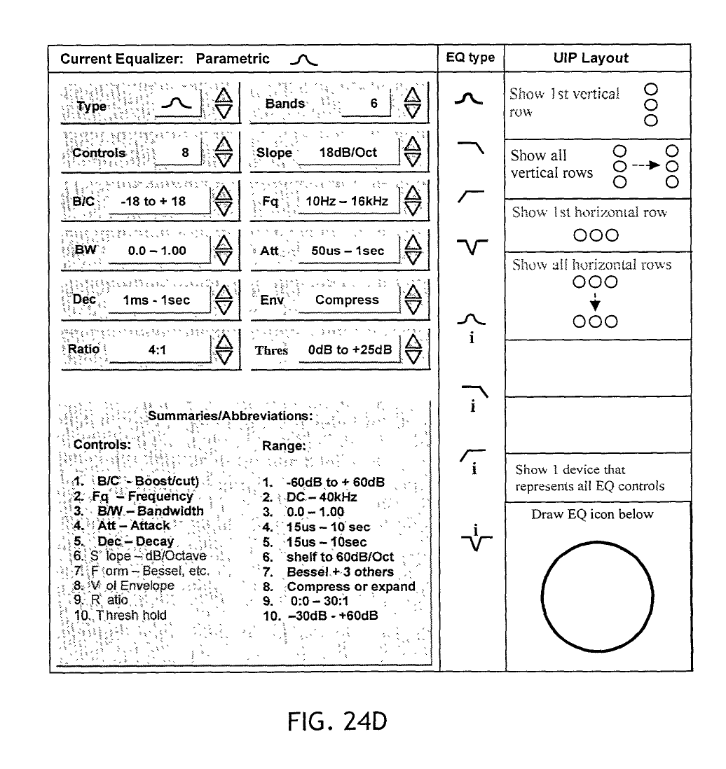

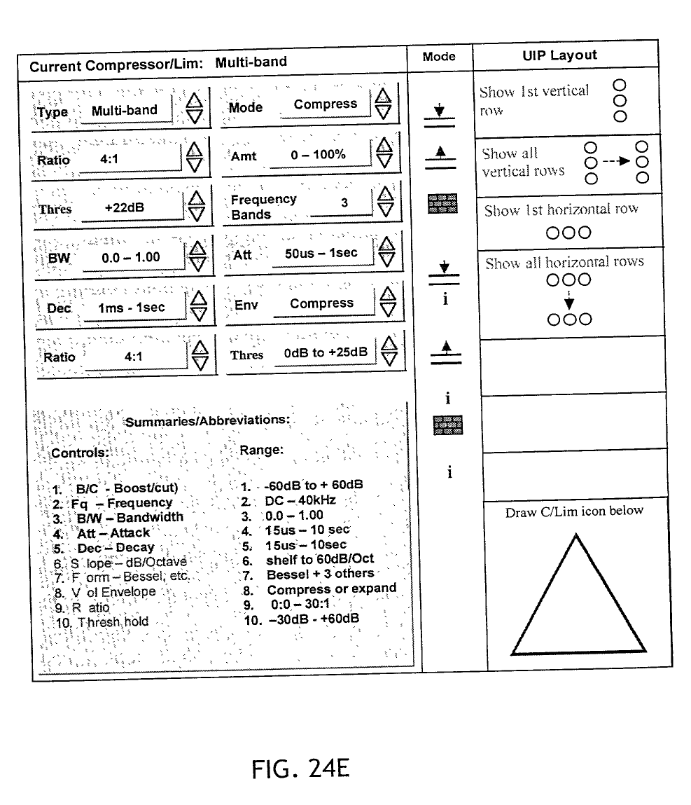

A user can designate a hand drawn object to directly equal a certain type of device. For instance, a blue rectangle can be designated to equal a four band parametric equalizer. There are various methods to enact this designation. Some of them are shown in FIGS. 24A-24E.

Method 1:

Drawing an arrow from a hand drawn object to the name of a device that this hand drawn object is to equal (FIG. 24A). In this case, “Four band parametric equalizer” will have a specification list in the software which specifies four knobs, each with individual capabilities and parameters, where all four knobs equal the functional device: “four band parametric equalizer”.

Method 2:

Typing an equal sign following by the name of a device that this hand drawn object is to equal (FIG. 24B).

Method 3:

Drawing an ellipse around a functional device with an arrow from the hand drawn ellipse to a hand drawn object that is to equal the device(s) enclosed by the ellipse. In this case, a star becomes a 3 band parametric equalizer (FIG. 24C).

Method 4:

Using a programming window to make user-selections that determine a functional device, then drawing a hand drawn graphic in this window, which drawing will equal the device that is programmed in this window. In this case, a circle (color may be specified) equals a six band parametric equalizer (FIG. 24D).

In a further example of the same type window as above, shown in FIG. 24E, this window may used to program a triangle (color may be specified) to be a specific setup for a multi/band compressor/limiter.

B. Using Graphics to Program a Hand Drawn Object as a Functional Device Without an Info Window or an Equivalent Menu.

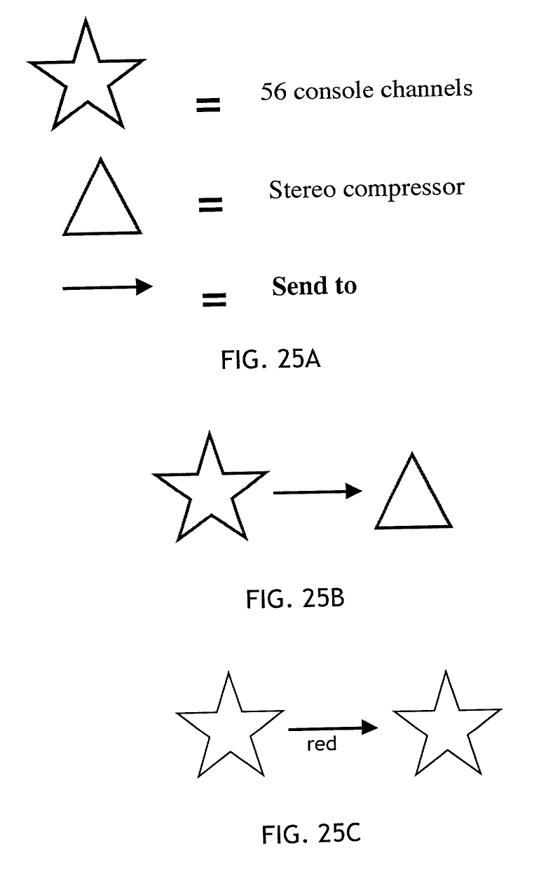

Using the methods provided for in this software, hand drawn devices that represent a functional device can, themselves, be used to program other hand drawn objects. Such programming can be done without a menu or window. Such programming can be done in blank space on a display. See FIG. 25A. A (green) star equals 56 console channels and a (red) triangle equals a stereo compressor and a black arrow stands for “send to”. Illustrating the power of this approach, for a user to send all 56 channels of a console to a compressor, the user need only enter the graphic objects of FIG. 25B. As a further example, an arrow may be used to copy an object by drawing the arrow from an object to a blank space on the display. In addition, if a command is entered by writing or typing a command word proximate to the arrow, the attributes conveyed by the arrow may be modified. Thus, in FIG. 25C, the star on the left is copied as a red object, regardless of the color of the star on the left.

More about Assigning Functions to Hand Drawn Graphics and the Linking and/or Grouping of Such Graphics.

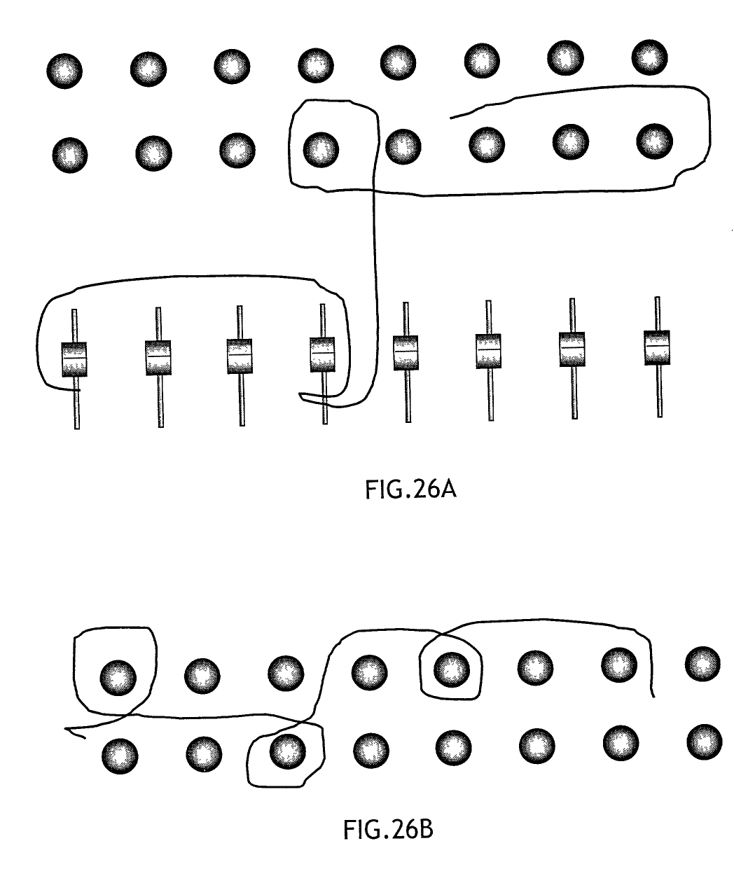

Furthermore, any function symbol, such as a knob or switch, may be cut, copied, moved, and pasted, as is commonly done in graphics programs and word processing programs. Thus it is easy for the user of this invention to create an array of switches and knobs and faders, similar to a standard audio mixing suite used in recording and audio production. As shown in FIG. 26A, a plurality of knobs and fader controllers may be created on the system display, using the techniques described previously. These controls may be assigned whatever functions are appropriate for the tasks the user wishes to carry out. Attributes of any control on-screen may be copied and pasted to another controller that is on-screen, using techniques common to graphic user interface machines.

In addition, with further reference to FIG. 26A, hand drawn line inputs may be used to associate the functions of selected on-screen devices with other such devices. For example, the hand drawn line of FIG. 26A circumscribes the five knobs of the lower row, thus causing them to be grouped and thus to operate in synchrony. In addition, the line continues to substantially circumscribe the four fader controllers at the left of the row of faders, thereby selecting those four fader controllers and linking their operation to the operation of the five knob controls. As a further example, shown in FIG. 26B, a hand drawn line loops about knobs previously placed on a screen, the loops selecting the first , fifth, and seventh knobs of the top row with the third knob of the second row. This technique is called “closed ellipses”. Referring again to FIG. 26B, as long as the multiple drawn ellipses are closed, the knobs in between the closed ellipses will not be selected or grouped. The software interprets this selection as a command to link these selected knobs to operate in synchrony. This is an example of on-the-fly, real time associative programming via hand drawn graphics.

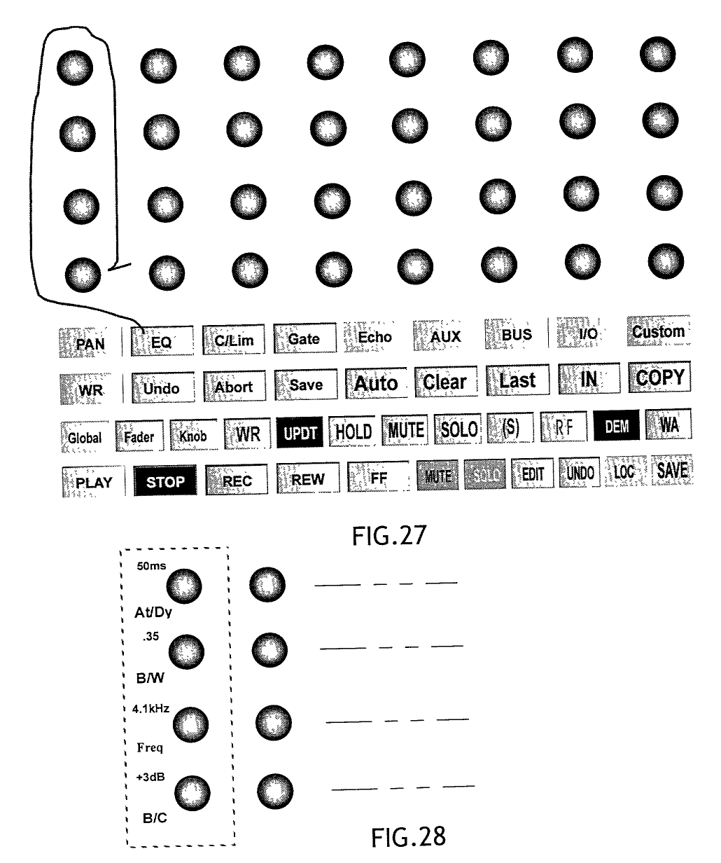

Likewise, as shown in FIG. 27, a plurality of knobs may be selected by a portion of a drawn line, with one end of the line leading to a function switch EQ (which stands for “equalizer”). Immediately following this input, the program designates the EQ functions for the selected knobs, as shown in FIG. 28, and displays the appropriate control functions for the selected knobs (shown in the broken line box). Various functions presented by the switch rectangles may be designated for any of the knob controllers by a similar line drawing gesture.

It must be emphasized that the act of creating the controls on-screen using hand drawn symbols, and thereafter designating functions and roles for the symbols, as in the example of FIGS. 27-28, comprises the single level of programming architecture required for the user to create and construct a complete program for the system. The software of the invention converts the on-screen arrangement to appropriate code to operate a programmable system that generates all the drawn functions, enables the drawn controls, establishes the drawn functional connections, and produces a desired result.

In addition, the act of drawing a line through a selected plurality of controllers could signify that the controllers are linked in function, action and/or movement. Or such a drawing could simply select all of the devices through which it is drawn. As shown in FIG. 29, the single hand drawn line through the five leftmost fader controllers joins them so that adjustment of any one of them results in the same proportional adjustment being applied to all of them. These faders are ganged together. These ganged faders may be operated on screen as virtual controls by touching one of the fader cap objects and sliding up or down along the fader track graphic. Alternately, a physical device, such as a crack-and-peel fader device, may be applied to one of the ganged fader images, and manipulated physically to alter the settings of the ganged fader controllers.

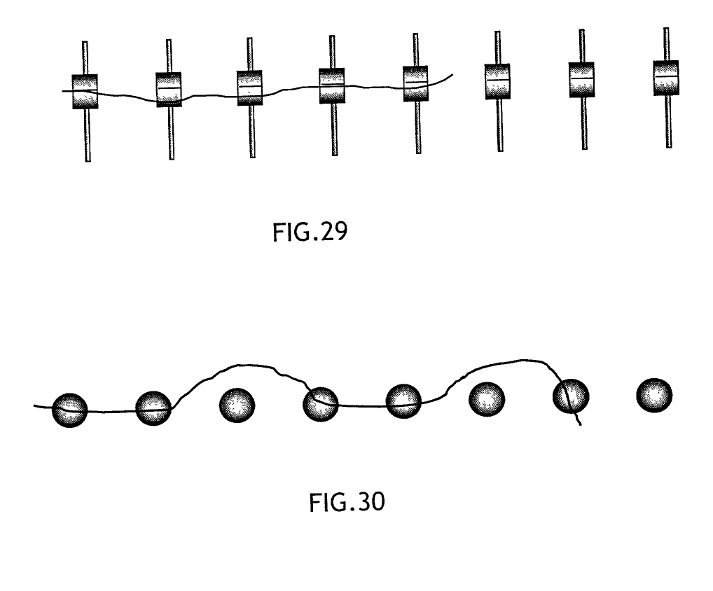

Likewise, as shown in FIG. 30, the connecting line curves and bends to select controls that are not necessarily adjacent, so that, e.g., proceeding from the left the first, second, fourth, fifth, and seventh knobs are linked, while the remaining knobs are independent or available for linking to other controllers.

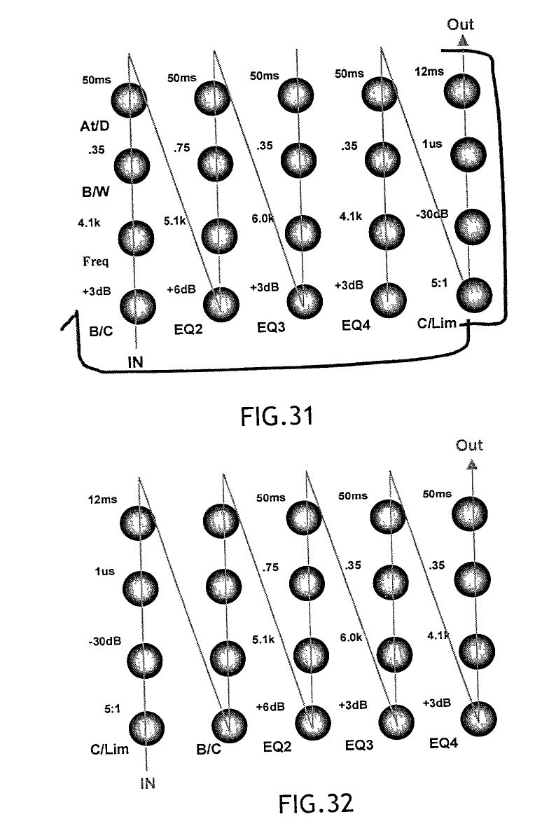

As shown in FIG. 31, the default flow of a signal is from the lower left-most device, vertically through the left-most column of controls, thence to the lower most device of the adjacent column of controls, and so on to the output, as is delineated by the flow lines of FIG. 31. In this example, the signal proceeds from IN at B/C (boost/cut) to EQ2, EQ3, EQ4, and C/Lim (compression/limiter) to the signal output. This default and placement of devices is recognized by the software, which directs at least one DSP (digital signal processor) to carry out the functions shown and permit the adjustments of the controls shown. To change this arrangement, the user may draw a vertical bracket to select the C/Lim column, and draw an arrow (drawn with a half arrow head) from the selected C/Lim column of knobs to the signal input position at the lower left IN position of the five vertical rows of knobs. Immediately thereafter, the software re-orders and redraws the rows of knobs and the processing signal path that the knobs represent, as shown in FIG. 32, so that the C/Lim device (the four vertical knobs comprising the compressor/limiter) is moved to the leftmost position and receives the input. Accordingly, the remaining chain of devices remains intact, with the output being delivered from the EQ4 stage. This revision of the knob rows and the processing that they control is accomplished with an absolute minimum of graphic input by the user.

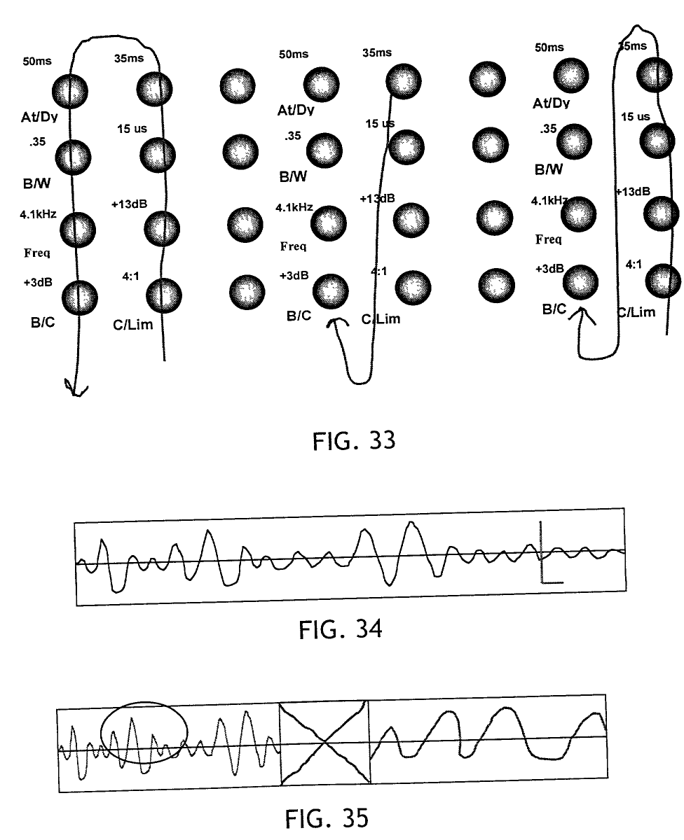

The default signal flow direction may be reversed with a simple hand drawn command. As shown in FIG. 33, any of the arrow gestures depicted may be used to reverse the signal flow so that the signal first enters the C/Lim device and is output through the equalizer (depicted with four vertical controls −B/C (boost/cut), Freq (frequency), B/W (bandwidth) and At/Dy (attack/decay).

The Chop Tool and Examples of Context

A further example of the functionality of the present invention, shown in FIG. 34, also illustrates the use of context in hand drawn object recognition. A vertical half bracket, comprised of a vertical stroke and a horizontal tail at the lower end, may go unrecognized if drawn in a blank space on the screen, or may be recognized as a vertical bracket that operates to combine other graphic objects that are within its span. However, if the vertical half bracket is drawn over a waveform display, this context directs the software to recognize the object as a chop bracket or chop tool (also shown in the chart of FIG. 23). The chop tool will cut the waveform at the exact point where it is drawn on the waveform. The Info Window for the chop tool sets forth that the direction of the tail (to the right) indicates that the audio signal to the right will be cut away, and the audio signal to the left will remain. If desired, this mode of operation could be reversed in the Global Info Window for the chop tool. In this case, the audio signal to the left will be cut away and the audio signal to the right will remain.

Chop Tool Used for Editing Graphics

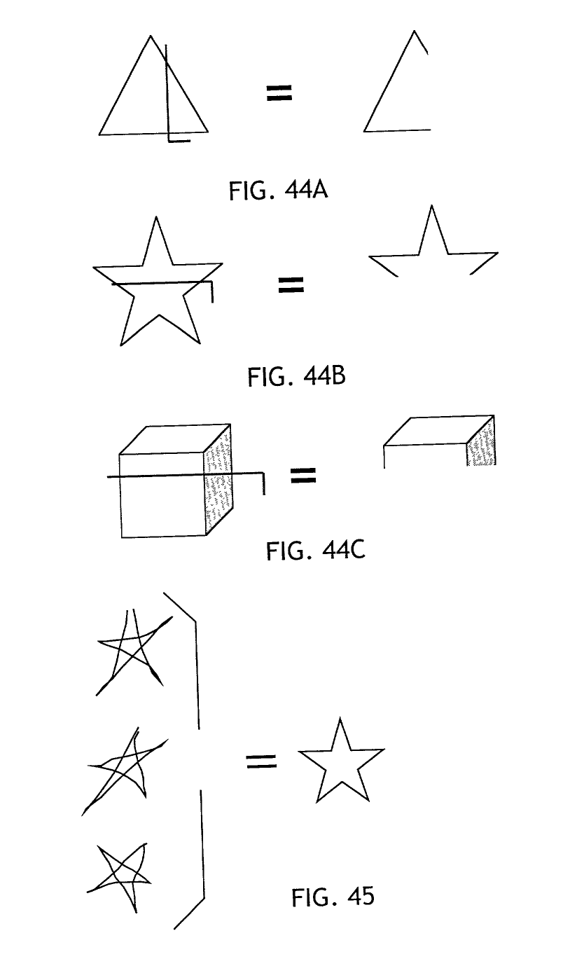

The chop tool is not only usable for editing audio files, but it can also be used to edit any graphic. When the chop tool is drawn through any graphic it cuts that graphic along the stroke that was drawn through the graphic. Furthermore, the angled end (the “tail”) of the chop tool can determine which portion of the graphic is kept and which portion is cut away. This is programmed in the Info Window for the Chop Tool. The default for this “tail” is that the direction that the “tail” is pointing determines the portion of the graphic that is cut away. FIGS. 44A-44C shows several examples of using the Chop Tool for cutting graphics, such as truncating a triangle or a star, or chopping a perspective view of an object, such as a cube. Note: The cutting of such graphics with the chop tool could yield closed chopped objects rather than the open chopped objects as shown in FIGS. 44A-44C. For the purpose of example, looking at FIG. 44A, a closed chopped triangle would have a line connecting the open ends of the cut lines for this triangle. By connecting such lines, the resulting chopped triangle will become a closed object.

“X” Graphic

With regard to FIG. 35, an “X” graphic may be drawn on-screen. If drawn on a blank portion of the screen, it may go unrecognized, or be recognized as the letter X. However, the “X” graphic may be a functional object if the context supports it. For example, if the “X” graphic is drawn over a waveform display, this particular context can determine that this X graphic is recognized as an audio crossfade. The line of the X graphic proceeding from upper left to lower right indicates the outfade for the waveform to the left of the graphic, and the line proceeding from lower left to upper right indicates the infade for the waveform to the right of the graphic.

Another use of the X graphic could be drawing an “X” over top of something that you want to delete. The drawing of the “X” establishes its aesthetic properties. The definition of the “X” is simply that it is an “X”. If this “X” is drawn over the top of another object, text or graphic device, its assignment is that object, text or graphic device and its function would be “delete the object, text or graphic device that it has been drawn over”. Similarly, referring to the crossfade example above, the assignment of the “X” would be to an audio waveform and the action of the “X” would be to create a certain type of crossfade for this waveform.

More on Context

Note that in FIG. 35 an ellipse has been drawn over the waveform display. Whether this ellipse has a function or not within this particular context will depend upon whether a provision for such a context exists for the object “ellipse”. Such a context would need to provide that an ellipse serves some purpose being drawn in a manner that overlaps a waveform display. If no such provision for such a context for an ellipse exists, then the drawing of such an ellipse will have no function other than being a visible elliptical graphic drawn over a waveform display. In other words, without an assigned function or action, the drawing of such an ellipse will not initiate any type of function or action. Note that an Info Window (global or individual) may be used to impart some functionality to the ellipse in the context of a waveform display, if the user so desires.

Programming a Folder with Hand Drawn Graphics

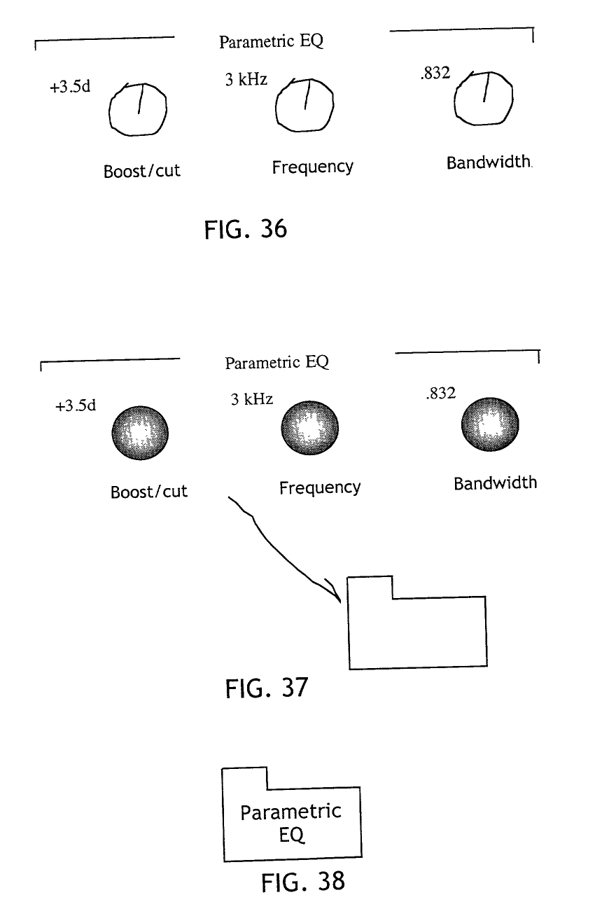

With regard to FIGS. 36-38, there is shown a further example of the flexibility and power of the on-screen graphic programming of the invention. A trio of knob controllers is drawn, given individual attributes (Boost/cut, Frequency, and Bandwidth) and joined by a bracket to comprise a parametric equalizer. These hand drawn objects are recognized and redrawn by the computer as shown in FIG. 37, thereby becoming a finished device that is fully functional. A folder object may then be drawn on-screen, and an arrow may be drawn from the vicinity of the parametric EQ to the folder. In this case, the arrow stores the object from which it is drawn in the object to which it is drawn. The resulting change in the folder is reflected in the new label for the folder, as shown in FIG. 38. And the folder now contains a three knob parametric equalizer.

Rules for Object Recognition

Rules enable a user to draw objects in their own personal style; how the object is drawn is an important determining factor in recognizing it, as opposed to merely how it looks. Users of this software generally would not need to learn to draw objects. On the contrary, one value of optimizing rules for the recognition of each hand drawn object is to permit the maximum number of users to draw these objects in ways they are already accustomed to, and have them recognized with a high degree of accuracy.

This software utilizes rules in order to recognize hand drawn objects. Generally, there is a different set of rules for each hand drawn object that this software recognizes, but not always. Although there is a finite set of objects that this software recognizes, new objects can be added to this recognition software. When this is accomplished, a new set of rules will usually be created for that object. Two purposes of using rules for object recognition is that these rules can be customized for each object and then further modified to improve both the speed and accuracy of recognition. In fact, the examples of rules provided herein, may themselves be changed in the course of improving the efficiency of the recognition algorithm for the objects provided as examples. Before some of the specifics of rules are presented, it is useful to understand that the types of tests and the order that those tests are performed may also vary from object to object.

Recognition Tests for Individual Hand Drawn Objects.

The tests that are used to recognize various objects are arrived at by a combination of analytical approaches and experimentation. The order of tests and type of tests that are used to recognize any given hand drawn object are optimized for that object. Eventually these tests are fixed for each type of object, but these tests can be changed if greater accuracy of recognition is required for any given object. An example of this would be for two objects that are very similar in their geometry. In order to maximize the accuracy of recognition and minimize any confusion between the two objects, the individual order and/or types of tests for each object may need to be altered.

As an example, the software may first test for the object that was drawn most recently. In many cases, the drawing of objects is so intuitive and fast that the drawing of such objects is faster than copying and pasting or duplicating such objects to achieve multiple entries of the same object. Furthermore, the software enables users to draw the proportions and orientations of objects where the drawing of such objects automatically creates such proportions and orientations. An example of this is the entry of a fader controller. The location of the fader cap along the track is determined by the hand drawn entry, and may differ for each such entry. Merely copying and pasting results in identical placements of the fader cap, whereas quick hand drawn entries can place the fader caps where they are desired.

Furthermore, in a setup page of an info window for the action of testing for object recognition, this logic could be defined to be “test for previously drawn object first.” The specific first test for each object may also be user defined. For instance, a user could define that the test for a single stroke folder is the Wide Pen Test. Therefore, if multiple folders are being drawn, regardless of what tests are used to recognize the first hand drawn folder, the rest of the folders drawn in sequence would be governed by the user-defined tests denoted in one or more info windows.

Below is a partial list of hand drawn objects and the tests that are performed for their recognition.

Folder Tests:

Size test

Wide pen test

Rectangle Tests:

Size test

Number of segments

$$\begin{matrix}Looks for vertices \\ Looks at length \\ Looks at golden clues\end{matrix} \} Checks at the same time$$

Looks at golden clues

Star Tests:

Bounding rectangle test

Determines that end of stroke is within certain distance of start of stroke;

Determines how apart the end of stroke is from start of stroke gap.

Analyzes vertices and angles.

Tic Mark Tests:

Number of segments is 2 or three

Length and angle

Checks the direction of the stroke

Fader Tests:

Checks how straight the vertical line or horizontal line is

Checks that the trend is not too great.

Checks if the angle is vertical or horizontal

Various tests which look at the size and position of the loop for the fader cap relative to the straight line. Where does rectangle intersect the line.

Triangle Tests:

Size test

Number of segments

Looks for vertices

Looks at length

Looks at golden clues.

Folder: (Single Stroke) Tests:

Just wide pen test

Folder (Double Stroke) Tests::

Check for a square or rectangle being recognized

Analyzes for the tab—uses same test as for a meter

Looks for the intersection of each side of the tab

Looks where the tab is drawn

Rules for the Recognition of Hand Drawn Objects

As mentioned previously, each object generally requires unique rules for its recognition. Some objects have much more complicated rules than others. Of the objects listed below, the rectangle has the most complex set of rules. In fact, what is shown is a partial set of recognition rules for this rectangle. Illustrated below are the following objects: rectangle, star and checkmark. It should be noted that as these object's recognition is refined, these lists of rules will change. This is part of the advantage of using rules for recognition. In addition, the list of rules is accessible by the user, and different numerical values may be entered to modify the rules as the user desires.

Rules for Recognizing a Rectangle (Partial List) The algorithm looks for the difference between the end-to-end segment angles first—it measures the angle between segments and looks for angles that are greater than 65 and less than 110. This is the initial test.

If this test passes, the algorithm (“it”) then increments a counter that counts the number of angles that are encountered.

It then measures the difference between the finish angle of the first segment and the start angle of the second segment.

Whichever is nearest to 90 degrees (the difference between the end-to-end angle of the first segment and the end-to-end angle of the second segment or the difference between the finish angle of the first segment and the start angle of the second segment) it subtracts this angle from 90 degrees and then subtracts that value from the number 15.

Then if the end-to-end angle of the first segment's difference from being vertical or horizontal is less than this number and also the same is true for the second segment, then if the straightness of both segments is greater than 70, this is a golden clue.

(Note: the number 15 is magic number. It's derived from experiments for best recognition)

Rules for Recognizing a Star

It measures the end-to-end angles between the segments.

If the angle is greater than 144 and less than 164 degrees, then it has found a vertex of a five point star.

If the angle does not fall between these two numbers, but is greater than 15 degrees, then it records an error for this vertex.

It continues to analyze all of the vertices. If at any time the number of errors becomes greater than 2, then the test fails.

If the number of vertices exceeds four then the object passes the test.

Rules for Recognizing a Check Mark

The number of segments for a check mark is 2 or 3.

The size test is 15 by 15 pixels minimum and 100 by 100 pixels maximum. Regarding the end-to-end angle of the segments, there are two sets of angles:

For a right hand check mark, the first end-to-end angle must be greater 190 and less than 260. This is measured from a zero angle with a stroke pointing left.

For a right handed check mark, the end-to-end of the second stroke is greater than 100 and less than 170.

For a left handed check mark the end-to-end angle of the first segment must be greater than 280 and less than 350. And the end-to-end angle of the second segment must be greater than 10 and less than 80.

The rules for recognizing these objects accepts a wide range of drawing styles to be used while still providing recognition of the intended object. For example, as shown in FIG. 45, three very different styles and forms of a hand drawn star may be recognized as stars, due to the fact that they meet the terms of the rules. This shows that the software does not require nor enforce rigid conformity of the hand drawn entry to a preconceived form in order for a hand drawn entry to be recognized.

The software described herein may also be used to recognize alphanumeric characters that are hand written with an input device.

Hand Drawn Graphics for Programming a Telephone

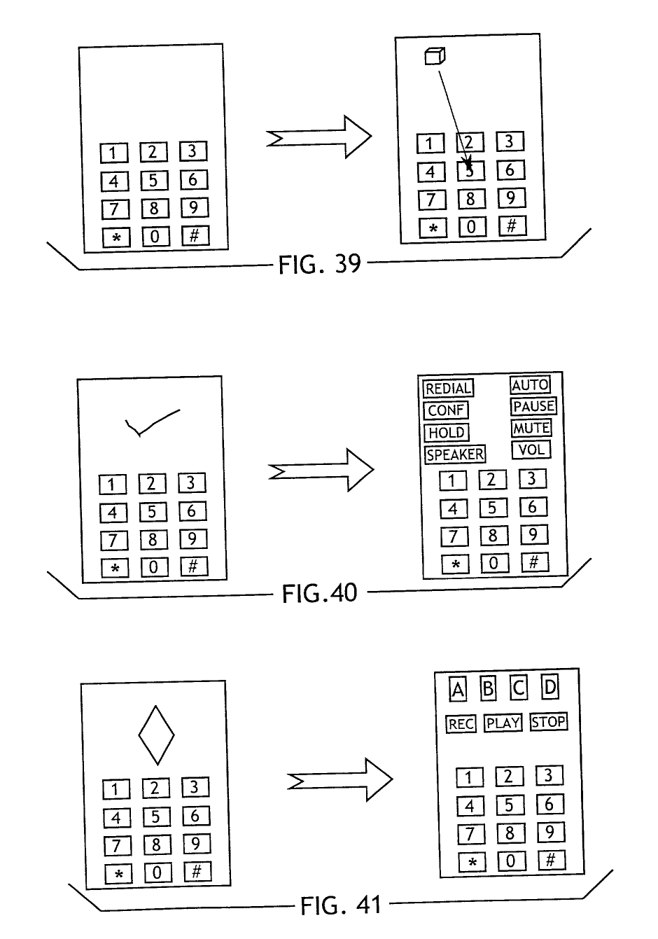

The powerful hand drawn graphics programming of the invention may be extended to more mundane electronic devices. As shown in FIG. 39 (left), a telephone may include a touch screen, on which is displayed a number pad typically used for telephone number entry. Each digit of the number pad may also represent a multi-digit telephone number that may be executed by touching the respective digit. The user may wish to block calls coming from an individual whose telephone number is represented by one of the digits. To initiate such selective call blocking, the user need only draw a blocking symbol, such as the “block” shown in FIG. 39 (right), with an arrow extending from the block to the digit representing the individual's telephone number. The phone's software will then be modified so that all incoming calls from that number will be blocked.

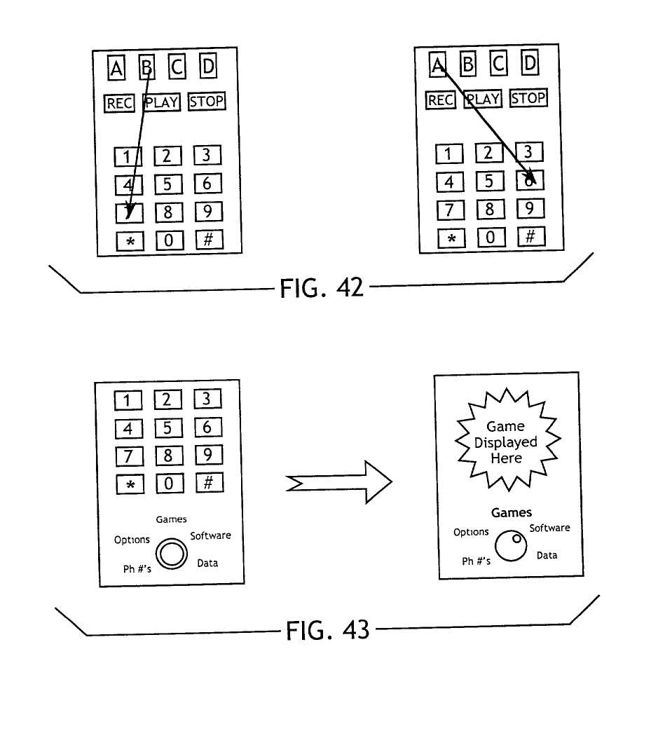

Further telephone functionality may be implemented by the present invention. With reference to FIG. 40, the telephone device of FIG. 39 may be arranged (through the use of Info Windows) so that the user may simply draw a check mark on the screen (FIG. 40 left) to evoke a display of further telephone controls typically provided on telephones (FIG. 40 right). Likewise, another graphic object, such as a diamond shape (FIG. 41 left) may be designated to evoke the display of controls for a telephone answering machine (FIG. 41 right). Aside from the function buttons Rec, Play, and Stop, there are a plurality of labeled buttons that represent different answering messages to be played upon receipt of an incoming call. The user may draw an arrow from any message button to any of the number pad digits to direct the telephone to deliver that message to an incoming call from the telephone number represented by the digit to which the arrow is drawn. As shown in FIG. 42, different messages may be designated for different incoming calls. These functions depicted in FIGS. 39-42 are generally not available on prior art telephones, or are very costly options that are difficult to arrange or modify. Using the graphics system of the invention, setting up and using these functions are extremely easy to accomplish.

As shown in FIG. 43 (left), the telephone device described above may be altered by displaying a knob controller along with the number pad. A physical knob may be placed on the knob graphic object, and used to select any of a plurality of features options, numbers, games, or the like. If a game is selected, as shown in FIG. 43 (right), the number pad may disappear, to be replaced by the game display for the user. The knob may then be used as a joystick to play the selected game. Thus a generalized touch screen computer device may employ the graphic programming software of the invention to create or fully emulate a wide variety of digital devices, graphic devices, and electronic appliances.

There are infinite ways in which the drawn lines (arrow logics) that command, link, and alter devices may be used on-screen to combine various functional symbols to achieve a desired input. This graphic programming approach comprises a new programming language that may be adapted to many uses far afield from audio or video signal processing and recording.

The foregoing description of the preferred embodiment of the invention has been presented for purposes of illustration and description. It is not intended to be exhaustive or to limit the invention to the precise form disclosed, and many modifications and variations are possible in light of the above teaching without deviating from the spirit and the scope of the invention. The embodiment described is selected to best explain the principles of the invention and its practical application to thereby enable others skilled in the art to best utilize the invention in various embodiments and with various modifications as suited to the particular purpose contemplated. It is intended that the scope of the invention be defined by the claims appended hereto.

1. In an electronic device that accepts hand drawn entries, a method for recognizing the hand drawn entries, comprising the steps of:
receiving each hand drawn entry as a plurality of sequential points;
performing at least one of the following steps in any order:
measuring the size of the hand drawn entry and comparing the size of the hand drawn entry to a size range;
determining the existence and number and angles of vertices in a line which could be drawn between said points;
comparing the results of said at least one step to a set of rules, a favorable comparison leading to conclusive identification of the hand drawn entry as an identified shape.

2. The method for recognizing hand drawn entries of claim 1, wherein said at least one step includes determining the distance between said vertices.

3. The method for recognizing hand drawn entries of claim 1, wherein said at least one step includes performing a Wide Pen Test.

4. The method for recognizing hand drawn entries of claim 1, wherein said at least one step includes performing a test for Golden Clues.

5. The method for recognizing hand drawn entries of claim 1, wherein said at least one step includes the step of excluding identification of shapes that do not conform to said set of rules.

6. The method for recognizing hand drawn entries of claim 1, wherein said at least one step includes excluding identification of shapes that do not conform to said set of rules regarding size.

7. The method for recognizing hand drawn entries of claim 1, further including a plurality of hand drawn entries, each of said hand drawn entries being analyzed individually.

8. The method for recognizing hand drawn entries of claim 1, further including a plurality of hand drawn entries, said lines being agglomerated and analyzed as a single entity.

9. The method for recognizing hand drawn entries of claim 1, further including a plurality of hand drawn entries of different colors, said set of rules including color rules to determine agglomeration of said entries as a single entity.

10. The method for programming an electronic device of claim 1, further including the step of using arrow logics to establish attributes of said identified shape.

11. The method for programming an electronic device of claim 1, further including the step of creating an info window for at least one of said identified shapes, said info window enabling setting and altering attributes for said at least one identified shape.

12. The method for recognizing hand drawn entries of claim 1, further including the step of carrying out further analytic tests to determine the specific object type.

13. The method for recognizing hand drawn entries of claim 1, wherein said at least one step includes determining the angular trend of said plurality of sequential points.

14. The method for recognizing hand drawn entries of claim 13, further including the step of excluding identification of shapes that do not conform to said set of rules regarding angular trend.

15. The method for recognizing hand drawn entries of claim 1, wherein said step of measuring the size includes the step of generating a minimum bounding rectangle to circumscribe the hand drawn entry.

16. The method for recognizing hand drawn entries of claim 15, further including the step of determining the size of said bounding rectangle, and comparing said size to size rules for at least one identifiable shape.

17. The method for recognizing hand drawn entries of claim 3, wherein said wide pen test includes the step of generating a minimum bounding rectangle to circumscribe the hand drawn entry.

18. The method for recognizing hand drawn entries of claim 17, further including the step of generating at least one identifiable geometric shape inscribed in said bounding rectangle, and comparing the coincidence of said points of said hand drawn entry with a wide pen stroke defining at least one identifiable geometric shape.

19. The method for recognizing hand drawn entries of claim 18, wherein said wide pen stroke is selected to be a predetermined width, and further including the step of adaptively altering said predetermined wide pen stroke width.

20. The method for recognizing hand drawn entries of claim 19, wherein the identifiable geometric shape yielding a degree of coincidence greater than a predetermined coincidence threshold is determined to be the shape of said hand drawn entry.

21. The method for recognizing hand drawn entries of claim 20, further including the step of adaptively altering said coincidence threshold.

22. The method for recognizing hand drawn entries of claim 20, further including the step of determining the angular trend of said hand drawn entry.

23. The method for programming an electronic device of claim 11, including the step of drawing at least one arrow from an attribute shown in an info window to at least one identified shape outside said info window.

24. The method for recognizing hand drawn entries of claim 1, further including the step of determining the angular orientation of said hand drawn entry with respect to a reference orientation.

25. The method for recognizing hand drawn entries of claim 24, further including the step of excluding identification of shapes that do not conform to said set of rules regarding angular orientation.

26. The method for recognizing hand drawn entries of claim 1, further including the step of determining the proximity of said hand drawn entry to another graphic object.

27. The method for recognizing hand drawn entries of claim 26, further including the step of excluding identification of shapes that do not conform to said set of rules regarding maximum proximate distance to said another graphic object.

29. The method for recognizing hand drawn entries of claim 1, further including the step of identifying a portion of said hand drawn entry drawn more slowly than other portions of said hand drawn entry.

30. The method for recognizing hand drawn entries of claim 29, further including the step of determining the existence of a vertex in said portion of said hand drawn entry, and calculating the vertex angle.

31. The method for recognizing hand drawn entries of claim 29, wherein said portion of said hand drawn entry is identified by storing and analyzing time of entry data of said plurality of points.

32. The method for recognizing hand drawn entries of claim 30, wherein if a vertex angle in said portion of said hand drawn entry is substantially orthogonal, said golden clue test provides increased potential for identifying a rectilinear shape.

33. The method for recognizing hand drawn entries of claim 30, wherein if a vertex angle in said portion of said hand drawn entry is substantially non-orthogonal, said golden clue test provides increased potential for exclusion of all rectilinear shapes.

34. The method for recognizing hand drawn entries of claim 30, wherein if a pair of vertex angles in said portion of said hand drawn entry are substantially orthogonal, proximate, and opposite, said golden clue test provides increased potential for identification of a folder shape.

35. The method for recognizing hand drawn entries of claim 30, wherein said golden clue test includes identifying a first-drawn portion of said hand drawn entry, determining the existence of a vertex in said first drawn portion of said hand drawn entry, and calculating the vertex angle.

36. The method for recognizing hand drawn entries of claim 35, wherein if a vertex angle in said first-drawn portion of said hand drawn entry is substantially orthogonal, said golden clue test provides increased potential for identification of rectilinear shapes.

37. The method for recognizing hand drawn entries of claim 35, wherein if a vertex angle in said first-drawn portion of said hand drawn entry is substantially non-orthogonal, said golden clue test provides increased potential for exclusion of all rectilinear shapes.

38. The method for recognizing hand drawn entries of claim 1, further including a slice step of identifying three of said points that are adjacent and spaced apart greater than a minimum pixel length distance, constructing an angle defined by said three points, measuring the constructed angle, and reiterating said slice step in serial fashion with consecutive points of said hand drawn entry to include substantially all said points of said hand drawn entry.

39. The method for recognizing hand drawn entries of claim 38, further including the step of storing the angle measurement of a slice when it exceeds a predetermined angle threshold.

40. The method for recognizing hand drawn entries of claim 39, further including the step of reducing said predetermined angle threshold whenever said reiterated slice step yields an angular measurement less than said predetermined angle threshold.

41. The method for recognizing hand drawn entries of claim 39, wherein if an angle measurement of a given slice step exceeds said predetermined angle threshold, and the angle measurement of the subsequent slice step is less than said predetermined angle threshold, a vertex is identified in the portion of said hand drawn entry containing said given slice step.

42. The method for recognizing hand drawn entries of claim 1, wherein said at least one step includes detecting and storing the first pen down location of said hand drawn entry.

43. The method for recognizing hand drawn entries of claim 1, wherein said at least one step includes detecting and storing the direction of the pen stroke of said hand drawn entry.

44. The method for recognizing hand drawn entries of claim 1, wherein said at least one step includes measuring the speed of drawing said hand drawn entry.

45. The method for recognizing hand drawn entries of claim 44, wherein said speed of drawing is determined by detecting the point-to-point spacing between said sequential points of said hand drawn entry, the point-to-point spacing varying directly with said speed of drawing.

46. The method for recognizing hand drawn entries of claim 44, wherein said speed of drawing is determined by recording the time of entry of each of said sequential points, and calculating the speed of drawing from said time of entry data.

47. The method for recognizing hand drawn entries of claim 1, further including the step of weighting the importance of the comparison of results to said set of rules, whereby some comparison results are accorded more importance in determining the identified shape.

48. The method for recognizing hand drawn entries of claim 1, wherein said results of said at least one step include numerical parameters that correspond to characteristics of said hand drawn entry, said numerical parameters being compared to stored magic number values.

49. The method for recognizing hand drawn entries of claim 48, wherein said magic number values are selectively varied in response to inconclusive comparisons to said set of rules.

50. The method for recognizing hand drawn entries of claim 49, wherein said magic number values can be selectively varied by user input.

51. In an electronic device that accepts hand drawn entries, a method for programming of said device, including the steps of:
using an input device to freehand draw at least one recognizable hand drawn entry;
performing at least one of the following steps in any order:
converting said at least one recognizable hand drawn entry into a functional device having a function that may be carried out by said electronic device;
converting said at least one recognizable hand drawn entry into an action that may be carried out by said electronic device.

52. The method for programming of claim 51, further including the step of assigning attributes to said recognizable hand drawn entry, said attributes defining said hand drawn entry as a functional device.

53. The method for programming of claim 51, further including the step of assigning attributes to said at least one recognizable hand drawn entry, said attributes comprising at least one action that may be carried out by said electronic device.

54. The method for programming of claim 51, further including the step of creating an info window for said at least one recognizable hand drawn entry, said info window enabling setting and altering attributes for said at least one hand drawn entry.

55. The method for programming of claim 51, further including the step of creating an info window for determining object recognition tests to identify said at least one recognizable hand drawn entry.

56. The method for programming of claim 51, further include the step of joining a plurality of functional devices in a utilitarian sequence.

57. The method for programming of claim 56, wherein said utilitarian sequence receives a designated input and produces a desired output.

58. The method for programming of claim 56, wherein said joining step includes the step of drawing at least one line extending to and intersecting said functional devices in said sequence.

59. The method for programming of claim 58, further including the step of selecting a line color for said at least one line, said functional devices being drawn in object colors, the coincidence of said line color and said object colors enabling the joining of said line and objects.

60. The method for programming of claim 51, further including the step of grouping a plurality of selected functional devices for action in common.

61. The method for programming of claim 60, wherein said grouping step includes the step of drawing a line that substantially circumscribes said selected functional devices.

62. The method for programming of claim 60, wherein said grouping step includes the step of drawing a line that substantially intersects said selected functional devices.

63. The method for programming of claim 60, wherein said grouping step includes the step of drawing a bracket that substantially spans said selected functional devices.

64. The method for programming of claim 51, further including the step of agglomerating at least two of said hand drawn entries into a single object.

65. The method for programming of claim 64, further including the step of enabling agglomeration only between at least two of said hand drawn entries having a common color.

66. The method for programming of claim 51, further including the step of applying functional parameters to a recognizable hand drawn entry by drawing a line from a functional device having defined functional parameters to a recognizable hand drawn entry lacking functional parameters.

67. The method for programming of claim 51, further including the step of assigning attributes to said at least one recognizable hand drawn entry by inputting text.

68. The method for programming of claim 51, further including the step of assigning attributes to said at least one recognizable hand drawn entry by making entries in an info window.

69. The method for programming of claim 51, further including the step of assigning attributes to said at least one recognizable hand drawn entry by inputting at least one verbal statement.

70. The method for programming of claim 51, further including providing an info window for each recognizable hand drawn entry, said info window enabling setting and altering attributes of said at least one recognizable hand drawn entry.

71. The method for programming of claim 70, wherein said info window attributes include the aesthetic properties of said recognizable hand drawn entry.

72. The method for programming of claim 70, wherein said info window attributes include the definition of recognizable hand drawn entry.

73. The method for programming of claim 70, wherein said info window attributes include the action of said recognizable hand drawn entry.

74. The method for programming of claim 70, wherein said info window attributes include the assignment of said recognizable hand drawn entry.

75. The method for programming of claim 74, wherein said assignment sets forth the ability of said recognizable hand drawn entry to acquire the attributes of another recognizable hand drawn entry that is disposed within a predetermined proximity.

76. The method for programming of claim 51, further including inputting a plurality of said recognizable hand drawn entries.

77. The method for programming of claim 76, further including the step of connecting said plurality of recognizable hand drawn entries.

78. The method for programming of claim 77, wherein said connected recognizable hand drawn entries receive a selected input and produce a desired output.

79. The method for programming of claim 77, wherein said step of connecting includes drawing a line that extends to each of said plurality of recognizable hand drawn entries.

80. The method for programming of claim 76, further including the step of grouping said plurality of recognizable hand drawn entries for action in common.

81. The method for programming of claim 80, wherein said grouping step includes drawing a bracket that encompasses said plurality of recognizable hand drawn entries.

82. The method for programming of claim 51, further including the step of using arrow logics to establish attributes of said at least one recognizable hand drawn entry.

83. The method for programming of claim 51, further including the step of applying a physical control device on-screen to said at least one functional device, said physical control device enabling a user to input variable control values to said at least one functional device.

84. The method for programming of claim 83, wherein said physical control device comprises a crack-and-peel controller.

85. The method for programming of claim 51, wherein said device includes a telephone, and further including the step of selective call blocking.

86. The method for programming of claim 85, including the step of assigning telephone numbers to a subset of said functional devices, drawing a symbol representing the call blocking function, and drawing an arrow from said symbol to one of said subset of functional devices to block calls from the telephone number represented by said one functional device.

87. The method for programming of claim 51, wherein said device includes a telephone, and further including the step of selective call answering.

88. The method for programming an electronic device of claim 87, including the step of assigning telephone numbers to a first subset of said functional devices, assigning different answering messages to a second subset of said functional devices, and drawing an arrow from one of said second subset of functional devices to one of said first subset of functional devices to assign the respective answering message to a call from a respective telephone number.

89. The method for programming an electronic device of claim 51, wherein said device displays a signal waveform, and said functional device comprises a chop tool juxtaposed over said signal waveform, said signal waveform being cut off at the point of intersection of said waveform and said chop tool.

90. The method for programming of claim 76, wherein said plurality of recognizable hand drawn entries comprise an audio control panel.

91. The method for programming of claim 76, further including the step of conveying the attributes of one functional device to another functional device by drawing an arrow from said one functional device to said another functional object.

92. The method for programming of claim 51, wherein said recognizable hand drawn entry comprises an arrow, and further including the step of recognizing the start point and end point of said arrow.

93. The method for programming of claim 92, wherein said arrow is assigned the function of conveying attributes from a recognizable hand drawn entry proximate to said starting point to a recognizable hand drawn entry proximate to said end point.

94. The method for programming of claim 92, wherein said arrow is assigned the function of copying a recognizable hand drawn entry proximate to said starting point to a location proximate to said end point.

95. The method for programming an electronic device of claim 11, including the step of drawing at least one arrow to an attribute shown in an info window from at least one identified shape outside said info window.

96. The method for recognizing hand drawn entries of claim 40, wherein the maximum total reduction of said predetermined angle threshold is determined by a user-defined parameter.

97. The method for programming of claim 51, further including the step of creating an info window for said at least one recognizable hand drawn entry, each info window storing parameters determining the function of said at least one recognizable hand drawn entry.

98. The method for programming an electronic device of claim 54, including the step of drawing at least one arrow to an attribute shown in an info window from at least one identified shape outside said info window.

99. The method for programming an electronic device of claim 54, including the step of drawing at least one arrow from an attribute shown in an info window to at least one identified shape outside said info window.

100. The method for programming an electronic device of claim 51, wherein said device displays a graphic object, and said functional device comprises a chop tool juxtaposed over said graphic object, said graphic object being cut off at the line of intersection of said graphic object and said chop tool.

101. The method for programming of claim 91, further including the step of modifying the attribute conveyed by an arrow by entering a text command proximate to said arrow.

102. The method for programming of claim 92, further including the step of providing an info window for said arrow, said info window enabling setting and modifying attributes of said arrow.

103. The method for programming of claim 70, wherein said info window attributes include the function of a recognizable hand drawn entry.
